(19) United States
(12) Patent Application Publication
(10) Pub. No.: US 2020/0223171 A1
(43) Pub. Date: Jul. 16, 2020

(54) ACOUSTIC COMPOSITE AND METHODS THEREOF

(71) Applicant: 3M INNOVATIVE PROPERTIES COMPANY, St. Paul, MN (US)

(72) Inventors: Tatjana STECENKO, Toronto (CA); Pingfan WU, Woodbury, MN (US); Jonathan H. ALEXANDER, Roseville, MN (US)

(21) Appl. No.: 16/647,806

(22) PCT Filed: Sep. 28, 2018
(86) PCT No.: PCT/IB2018/057575

§ 371 Date: Mar. 16, 2020

Related U.S. Application Data
(60) Provisional application No. 62/569,113, filed on Oct. 6, 2017.

(51) Int. Cl. B32B 3/26; B32B 5/18; B32B 5/02; B32B 7/02; E04B 1/84

(52) U.S. Cl. CPC B32B 3/266; B32B 5/18; B32B 5/02; B32B 7/02; E04B 1/84; B32B 2307/732; B32B 2323/10; B32B 2250/40; B32B 2307/102; B32B 2419/00; B32B 2305/026; B32B 2305/022; B32B 2262/101; B32B 2307/50

(57) ABSTRACT

The present disclosure provides an acoustic composite. The acoustic composite includes a first porous layer having a flow resistance in a range of from about 100 Rayl to about 150,000 Rayl. The acoustic composite further includes a second porous layer having a flow resistance in a range of from about 100 Rayl to about 150,000 Rayl. The acoustic composite further includes a perforated membrane adjacent to at least one of the first porous layer and the second porous layer. The perforated membrane includes a first surface and a second surface opposed to the first surface. The perforated membrane further includes a patterned arrangement of a plurality of through-holes each independently extending from a first open end, the first surface including the first open end, to a second open end, the second surface including the second open end.

### BACKGROUND

Acoustic materials are used for various applications. Such materials can be made of various components selected to lower transmission or absorb sound. As demands on acoustic absorbers and treatments increase, it is desirable to construct insulation that can function to effectively lower transmission or absorb sound over a wider frequency spectrum, including improvements in desirable low frequency range, not obtainable using conventional porous materials.

### SUMMARY OF THE DISCLOSURE

The present disclosure provides an acoustic composite. The acoustic composite includes a first porous layer having a flow resistance in a range of from about 100 Rayl to about 150,000 Rayl. The acoustic composite further includes a second porous layer having a flow resistance in a range of from about 100 Rayl to about 150,000 Rayl. The acoustic composite further includes a perforated membrane adjacent to at least one of the first porous layer and the second porous layer. The perforated membrane includes a first surface and a second surface opposed to the first surface. The perforated membrane further includes a patterned arrangement of a plurality of through-holes each independently extending from a first open end, the first surface including the first open end, to a second open end, the second surface including the second open end.

The present disclosure further provides an acoustic composite. The acoustic composite includes a first porous layer and optionally a second porous layer. The porous layers independently include a material chosen from a foam, a semi-crystalline fiber, a melt-blown fiber, a glass fiber, a fluoropolymer fiber, and a mixture thereof. At least one of the first porous layer and the second porous layer independently have a flow resistance in a range of from about 100 Rayl to about 150,000 Rayl and a variable density defined by a first portion having a first density and a second portion spaced transversely with respect to the first portion, having a second density different than the first density.

The present disclosure further provides an acoustic composite. The acoustic composite includes a first porous layer having a first density and a flow resistance in a range of from about 100 Rayl to about 150,000 Rayl. The acoustic composite further includes a second porous layer having a second density and a flow resistance in a range of from about 100 Rayl to about 150,000 Rayl. At least one of the first and second porous layers independently includes a material chosen from a foam, a semi-crystalline fiber, or a mixture thereof, and have a variable density. The acoustic composite further includes a perforated membrane adjacent to at least one of the first porous layer and the second porous layer. The perforated membrane includes a first surface and an opposed second surface. The perforated membrane further includes a plurality of tapered through holes extending from a first open end, defined by the first surface, to a second open end defined by the second surface, a first diameter of the first open end being greater than a second diameter of the second end. The first open end and the second open end of the tapered through-holes each have a profile defined by a generally circular perimeter or a polygonal perimeter.

The present disclosure further provides an assembly including an acoustic composite. The acoustic composite includes a first porous layer having a flow resistance in a range of from about 100 Rayl to about 150,000 Rayl. The acoustic composite further includes a second porous layer having a flow resistance in a range of from about 100 Rayl to about 150,000 Rayl. The acoustic composite further includes a perforated membrane adjacent to at least one of the first porous layer and the second porous layer. The perforated membrane includes a first surface and a second surface opposed to the first surface. The perforated membrane further includes a patterned arrangement of a plurality of through-holes each independently extending from a first open end, the first surface including the first open end, to a second open end, the second surface including the second open end. The assembly further includes a first panel and a second panel adjacent to the first porous layer and second porous layer respectively of the acoustic composite.

The present disclosure further provides a method of using an acoustic composite. The acoustic composite includes a first porous layer having a flow resistance in a range of from about 100 Rayl to about 150,000 Rayl. The acoustic composite further includes a second porous layer having a flow resistance in a range of from about 100 Rayl to about 150,000 Rayl. The acoustic composite further includes a perforated membrane adjacent to at least one of the first porous layer and the second porous layer. The perforated membrane includes a first surface and a second surface opposed to the first surface. The perforated membrane further includes a patterned arrangement of a plurality of through-holes each independently extending from a first open end, the first surface including the first open end, to a second open end, the second surface including the second open end. The method includes exposing the first open ends of the plurality of the through-holes to a noise source.

The present disclosure further provides a method of making an acoustic composite. The acoustic composite includes a first porous layer having a flow resistance in a range of from about 100 Rayl to about 150,000 Rayl. The acoustic composite further includes a second porous layer having a flow resistance in a range of from about 100 Rayl to about 150,000 Rayl. The acoustic composite further includes a perforated membrane adjacent to at least one of the first porous layer and the second porous layer. The perforated membrane includes a first surface and a second surface opposed to the first surface. The perforated membrane further includes a patterned arrangement of a plurality of through-holes each independently extending from a first open end, the first surface including the first open end, to a second open end, the second surface including the second open end. The method includes positioning the perforated membrane adjacent to at least one of the first porous layer and the second porous layer. The method further includes optionally coupling the perforated membrane to at least one of the first porous layer and the second porous layer.

Various embodiments according to this disclosure, provide certain advantages, at least some of which are unexpected. For example, according to some embodiments of the present disclosure, the acoustic composite can include a perforated membrane including a plurality of through-holes arranged according to a predetermined pattern. According to some embodiments of the present disclosure, the pattern can be described in terms of hole design and distribution. According to some embodiments of the present disclosure, the patterned arrangement can help to improve acoustic performance of the composite compared to a corresponding composite having a random distribution of through-holes. For example, according to some embodiments of the present disclosure, the through-holes can be sized and arranged to provide improved performance with respect to sound on opposite sides of the perforated membrane. For example, according to some embodiments of the present disclosure, the perforations can be sized to optimize absorption of sound to which a first side (e.g., facing an interior of a vehicle) is exposed while optimizing sound transmission loss to which a second side opposite the first side (e.g., facing an exterior of a vehicle) is exposed.

According to some embodiments of the present disclosure, the transmissivity loss of the acoustic composite is increased compared to a corresponding acoustic composite that is free of at least one of a perforated membrane including a plurality of through-holes arranged according to a predetermined pattern and a porous layer having a variable density. According to some embodiments of the present disclosure, the perforated membrane can be placed between flame resistant materials and comprise a material that is not flame resistant but has better acoustic performance than a corresponding material that is flame resistant. According to some embodiments of the present disclosure, the density of the porous layer adjacent the perforated membrane be locally increased or decreased to give a variable density. The variable density can increase the acoustic performance of the acoustic composite as compared to a corresponding acoustic composite that is free of a porous layer having a variable density. According to some embodiments of the present disclosure, the variable density of the porous layers can help to optimize the weight and thickness of the porous layers, which can help to make the acoustic composite to be better suited for aerospace applications where weight and size restrictions may be present. According to some embodiments of the present invention, the ability to optimize and control the thickness of the porous layers and acoustic composite as a whole can allow a designer to position areas of the porous layer with greater density or thickness near areas of a vehicle that are subjected to high levels of a particular noise such as a low-frequency noise.

Additionally, according to some embodiments of the present disclosure, a variable density of the porous layer can be achieved within a single porous layer. According to some embodiments of the present disclosure, this can be different than having to design a composite including a porous layer that is coupled to a second layer of a porous material having a different density in order to achieve a variable density or density gradient. According to some embodiments of the present disclosure, any variability of density or density gradient across the thickness of the porous layer can be achieved within one porous layer. According to some embodiments of the present disclosure, the ability to achieve a variable density or density gradient within the same porous layer can result in reduced thickness as well as reduced weight in the acoustic composite as compared to a corresponding acoustic composite that is free of at least one porous layer having a variable density. For example, according to some embodiments of the present disclosure, an acoustic composite including at least one porous layer having a variable density can have substantially the same or better acoustic performance than a corresponding acoustic composite that is free of the at least one porous layer or that includes multiple stacked porous layers each having a uniform density. According to some examples, of the present disclosure, the thickness as well as the weight of the corresponding acoustic composite can be in a range of from about 1.1 times to about 10 times as thick as the disclosed acoustic composite including a porous layer having a variable density.

According to some embodiments of the present disclosure, the acoustic composite is beneficial in performance compared a system using only a perforated membrane. According to some embodiments of the present disclosure, if only a perforated membrane, that is free of at least one porous layer, is used, the thermal resistance provided by the perforated membrane alone is not sufficient for various applications. Therefore, according to some embodiments of the present disclosure, the acoustic composite including at least one porous layer and perforated membrane can provide improved acoustic performance and thermal resistance.

According to some embodiments of the present disclosure, the acoustic composite can include an elastomeric membrane or barrier layer. According to some embodiments of the present disclosure, the elastomeric membrane can add mass to the acoustic composite which can help to improve the acoustic performance of the acoustic composite in selected applications. Additionally, according to some embodiments of the present disclosure, the elastomeric membrane can be used to modify the stiffness of the acoustic membrane.

According to some embodiments of the present disclosure, transmission losses of composites including the perforated membrane show an improvement in transmission loss of between about 0.8 dB to about 4 dB over a frequency range of about 315 Hz to about 5000 Hz. According to some embodiments of the present disclosure, composites including the perforated membrane show little to no resonance effect. According to some embodiments of the present disclosure, the resonance effect can refer to an instance where transmission loss over a low end of a frequency band shows a sudden non-linear decrease or dip. According to some embodiments of the present disclosure, however, the acoustic composite can act as a Helmholtz resonator to result in a more stable or liner curve of transmission over a frequency range of about 315 Hz to about 5000 Hz.

According to some embodiments of the present disclosure, the perforated membrane can include tapered through-holes. According to some embodiments, tapering the through-holes can lower hole density in the perforated membrane, which may result in more cost-effective manufacturing. Also, according to some embodiments, the reduced void volume may allow the perforated membrane to be more effectively used as a barrier to, for example, liquid water, water vapor, oil, dust and debris, and the like. According to some embodiments of the present disclosure, forming the through-holes to include a taper can increase efficiency and decrease cost in manufacturing the perforated membrane. Additionally, according to some embodiments of the present disclosure, the acoustic performance of the acoustic composite is also increased by including tapered through-holes in the perforated membrane as compared to a corresponding acoustic composite that is free of a perforated membrane including at least one tapered through-hole.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic depiction of an acoustic composite, in accordance with various embodiments.

FIG. 2 is a schematic depiction of another acoustic composite, in accordance with various embodiments.

FIG. 3 is a schematic sectional view of a porous layer, in accordance with various embodiments.

FIG. 4 is a schematic sectional view of a porous layer having a variable density, in accordance with various embodiments.

FIG. 5 is a schematic sectional view of a porous layer having a variable density and including solid filler component, in accordance with various embodiments.

FIG. 6 is a schematic sectional view of a porous layer having a variable density and including a perforated membrane, in accordance with various embodiments.

FIG. 7 is a schematic sectional view of a porous layer including an elastomeric membrane, in accordance with various embodiments.

FIG. 8, is a sectional schematic view of a porous layer including a variable density and free of protrusions, in accordance with various embodiments.

FIG. 9 is a top plan view of a perforated membrane, in accordance with various embodiments.

FIG. 10, is a partial sectional view of the perforated membrane taken along line 10-10 of FIG. 9, in accordance with various embodiments.

FIG. 11, is a flow chart showing a method of forming an acoustic composite, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

Sound absorbers have been widely used in a number of different disciplines for absorbing sound. Examples of sound absorbers are fiber-based and use fibrous materials such as fiberglass, open-cell polymeric foams, fibrous spray-on materials derived from polyurethanes, and acoustic tile (an agglomerate of fibrous and/or particulate materials). Such fibrous-based sound absorbers rely on frictional dissipation of sound energy in interstitial spaces and can advantageously provide relatively broad-band sound absorption. Despite their advantages in broad-band absorption, fiber-based sound absorbers have significant inherent disadvantages. Such sound absorbers can readily release particulate matter and deleteriously degrade the air quality of the surrounding environment. Some fiber-based sound absorbers are also sensitive to heat or fire and/or require expensive treatment to provide heat/fire resistance. Consequently, fiber-based sound absorbers can be of limited use in many environments.

Alternatively, perforated sheets or membranes have also been used in sound absorbers. These sheets include relatively thick perforated materials, such as metal, having relatively large hole diameters (e.g., greater than 1 mm hole diameters). The perforated sheets can be used in two manners. For example, they can be used alone with a reflective surface to provide narrow band sound absorption for relatively tonal sounds. They can also be used as facings for fibrous materials to provide sound absorption over a wider spectrum. In the latter case, the perforated sheets can serve as protection, with the fibrous materials providing the sound absorption. Microperforated, sheet-based sound absorbers have also been suggested for sound absorption. Conventional micro perforated sheet-based sound absorbers use either relatively thick (e.g., greater than 2 mm) and stiff perforated sheets of metal or glass or thinner perforated sheets which are provided externally supported or stiffened with reinforcing strips to eliminate vibration of the sheet when subject to incident sound waves.

While these perforated sheet-based sound absorbers may overcome some of the inherent disadvantages of fiber-based sound absorbers, such as the risk of releasing particulate debris, potential inherent heat sensitivity, or size, they can be expensive and/or of limited use in many applications. For instance, the use of very thick and/or very stiff materials or use of thickening strips or external support for the perforated sheets limits the use of sound absorbers using such sheets. The necessary thickness/stiffness or strips/external support also makes the perforated sheets expensive to manufacture. Finally, the perforated sheets may be provided with expensive narrow diameter perforations or else used in limited situations involving tonal sound. For example, to achieve broad-band sound absorption, conventional perforated sheets may be provided with perforations having high aspect ratios (hole depth to hole diameter ratios). However, the punching, stamping or laser drilling techniques used to form such small hole diameters are very expensive. Accordingly, the sound absorption industry still seeks sound absorbers which are inexpensive and capable of wide use. The present disclosure solves these as well as other needs, by in part providing an acoustic composite material that includes porous layers and a perforated membrane having a predetermined pattern of through-holes disposed thereon through facile manufacturing techniques at low costs.

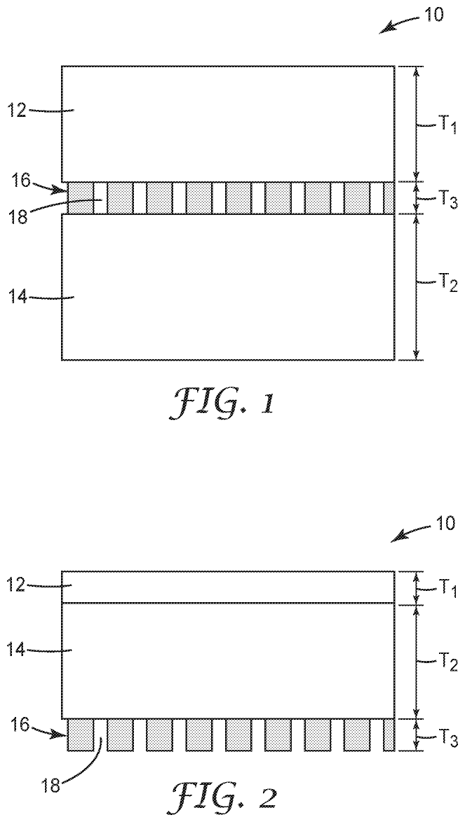

An acoustic composite is described herein. The acoustic composite is a sound absorber that can generally include a metamaterial. An example of an acoustic composite 10 is shown in FIGS. 1 and 2, which are schematic depictions of acoustic composite 10. FIGS. 1 and 2 show many of the same features and are discussed concurrently. As shown in FIG. 1, acoustic composite 10 includes first porous layer 12, second porous layer 14, and perforated membrane 16 (alternatively referred to as a microperforated film), including through-holes 18 (alternatively referred to as microperforations). As shown in FIG. 1, perforated membrane 16 is positioned between first porous layer 12 and second porous layer 14. In other examples, such as shown in FIG. 2, perforated membrane 16 is not positioned between porous layers 12 and 14, but rather is located outside of one of porous layers 12 and 14. Additionally, although acoustic composite 10 is shown as including two porous layers, further examples of acoustic composite 10 can include any other plural number of porous layers. For example, acoustic composite 10 can include three, four, five, or even six porous layers.

The physical properties of the components of acoustic composite 10 can be selected to control the acoustic performance or properties of composite 10. Acoustic properties of interest may include the sound absorption and transmissivity at a frequency in a range of from about 50 Hz to about 10,000 Hz. Physical properties such as thickness, density, and flexural modulus of individual components can affect the absorption and transmissivity of acoustic composite 10. For example, tuning these properties can allow acoustic composite 10 to selectively vibrate in response to an incident of sound, reduce vibration, or even resonate to alter the frequency of the sound.

First porous layer 12, second porous layer 14, or any other porous layer can be a lofty or non-lofty structure. The materials that are included in the individual porous layers and the properties thereof can affect the acoustic performance of the porous layers and acoustic composite 10 as a whole. Examples of suitable materials that can be included in first porous layer 12 and second porous layer 14 can include a foam, a melt spun fiber, a melt-blown fiber, a fluoropolymer fiber, a glass fiber, and a mixture thereof. The foam can be an open-cell foam or a closed-cell foam. The foam can include a polymer. The polymer can be chosen from a polyethylene, a polyurethane, a polylactic acid, a polypropylene, an ethylene and methacrylate ester copolymer, a polyphenylene sulfide, a copolymer thereof, and a mixture thereof. The polymer can be in a range of from about 80 wt % to about 100 wt % of the foam, about 95 wt % to about 100 wt % of the foam, or less than, equal to, or greater than about 80 wt %, 85, 90 ,95, or 100 wt % of the foam.

In examples where first porous layer 12 and second porous layer 14 include a fluoropolymer fiber, the fiber can include a polymer chosen from a polytetrafluoroethylene, a tetrafluoroethylene-hexafluoropropylene-vinylidene fluoride polymer, polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluoropolyether, a copolymer thereof, and a mixture thereof. The polymer can be in a range of from about 80 wt % to about 100 wt % of the fluoropolymer, about 95 wt % to about 100 wt % of the fluoropolymer, or less than, equal to, or greater than about 80 wt %, 85, 90, 95, or 100 wt % of the fluoropolymer.

In further examples, first porous layer 12 and second porous layer 14 can include a semi-crystalline fiber. The semi-crystalline fiber can include a polymer that is chosen from a polyolefin, a polypropylene, a polyethylene, a polyester, a polyethylene terephthalate, a polybutylene terephthalate, a polyamide, a polyurethane, a polybutene, a polylactic acid, a polyphenylene sulfide, a polysulfone, a liquid crystalline polymer, a polyethylene-co-vinylacetate, a polyacrylonitrile, a cyclic polyolefin, a polyamide, an acrylic, a rayon, a cellulose acetate, a polyvinyl chloride, a polyvinylidene chloride-vinyl chloride copolymer, a vinyl chloride-acrylonitrile copolymer, a copolymer thereof, a polyhydroxybutyrate, a polycaprolactone, a polyhydroxyalkanoate, a polyglycolide, a polybutylene succinate, a poly(3-hydroxybutyrate-co-3-hydroxyvalerate), a polyethylene adipate, a polyoxymethylene, a poly(vinylidine fluoride), a poly(ethylene-chlorotrifluoroethylene), a poly(vinyl fluoride), poly(ethylene oxide), a polycaprolactone, a semi-crystalline aliphatic polyamide, a thermotropic liquid crystal polymer, and a mixture thereof. The polymer can be in a range of from about 80 wt % to about 100 wt % of the semi-crystalline fiber, about 95 wt % to about 100 wt % of the semi-crystalline fiber, or less than, equal to, or greater than about 80 wt %, 85, 90 ,95, or 100 wt % of the semi-crystalline fiber. The semi-crystalline fiber can be a non-woven fiber.

Any one of the fibers described herein can have a median diameter of at least about 0.3 microns, at least about 0.5 microns, at least about 1 microns, at least about 5 microns, or at least about 10 micrometers. A linear density of the fibers can be in a range of from about 1 denier to about 15 denier, about 3 denier to about 8 denier, or less than, equal to, or greater than about 1 denier, 2, 3, 4, 5, 6, 7, 8, 9, 10, 11, 12, 13, 14, 15, 16, 17, 18, 19, or 20 denier. A Crimp Index Value of an individual fiber can range from about 15% to about 60%, about 25% to about 50%, less than, equal to, or greater than about 15%, 20, 25, 30, 35, 40, 45, 50, 55, or 60%. The Crimp Index Value is a measurement of a produced crimp; e.g., before appreciable crimp is induced in the fiber. The Crimp Index Value is expressed as the difference in length of the fiber in an extended state minus the length of the fiber in a relaxed (e.g., shortened) state divided by the length of the fiber in the extended state. Crimping the fibers can help to make the fibers easier to process. Additionally, crimping the fibers can help to increase the loft of porous layers 12 and 14 as compared to a corresponding porous layer that is free of crimped fibers or has fewer crimped fibers.

The acoustic performance of acoustic composite 10, as a whole, and the individual components can be a function of the flow resistance of first porous layer 12 and second porous layer 14. For example, first porous layer 12 and second porous layer 14 can, independently, have a flow resistance in a range of from about 100 Rayl to about 150,000 Rayl, about 200 Rayl to about 100,000 Rayl, about 500 Rayl to about 50,000 Rayl, or less than, equal to, or greater than about 100 Rayl, 200, 300, 400, 500, 600, 700, 800, 900, 1,000, 5,000, 10,000, 20,000, 30,000, 40,000, 50,000, 60,000, 70,000, 80,000, 90,000, 100,000, 110,000, 120,000, 130,000, 140,000, or about 150,000 Rayl. As used herein the unit “Rayl” can also be expressed as kg/(m²s).

The thickness of first porous layer 12 and second porous layer 14 (T₁ and T₂, respectively) can independently be in range of from about 3 mm to about 90 mm, about 20 mm to about 30 mm, or less than, equal to, or greater than about 3 mm, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74 ,74.5, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, or about 90 mm. As shown in FIGS. 1 and 2 the thickness of first porous layer 12 and second porous layer 14 are the same. However, in other examples the respective thickness can be different. Relative to each other, the thickness of first porous layer 12 can be in a range of from about 0.2 times to about 5 times as thick as the second porous layer 14, about 1 time to about 3 times as thick as second porous layer 14, or less than, equal to, or greater than about 0.2 times, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3 ,4.4, 4.5, 4.6, 4.7, 4.8, 4.9, or about 5.0 times as thick as second porous layer 14. Alternatively, the thickness of second porous layer 14 can be in a range of from about 0.2 times to about 5 times as thick as first porous layer 12, about 1 time to about 3 times as thick as first porous layer 12, or less than, equal to, or greater than about 0.2 times, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3 ,4.4, 4.5, 4.6, 4.7, 4.8, 4.9, or about 5.0 times as thick as first porous layer 12.

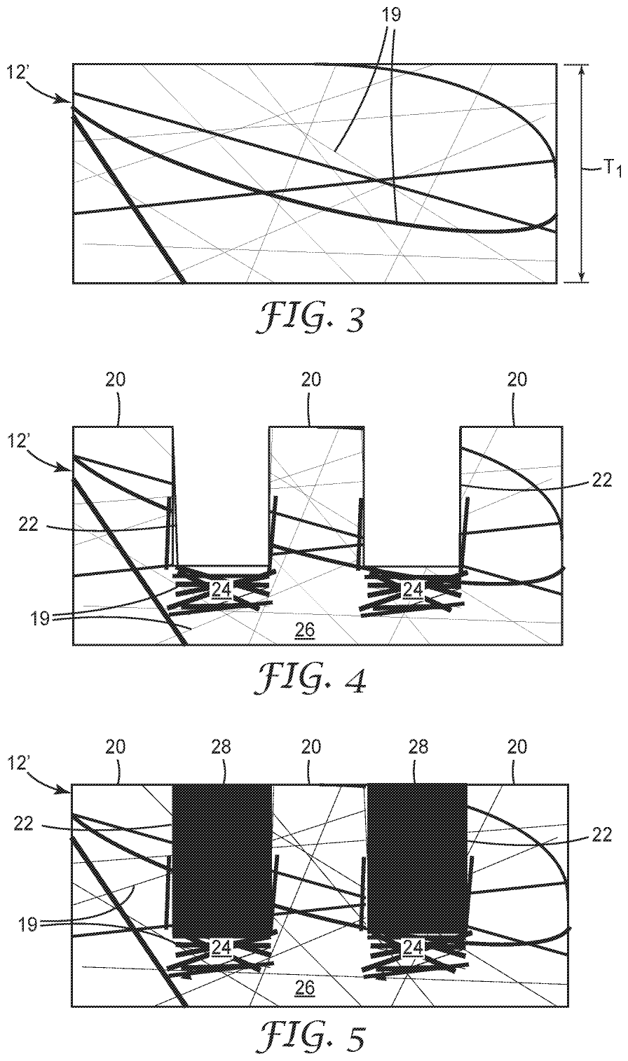

Another property of first porous layer 12 and second porous layer 14 that can affect the acoustic performance is the density of the porous layers. In some examples, the density of first porous layer 12 and second porous layer 14 is substantially the same (e.g., within about 5% of each other) In other examples, the density of first layer 12 and second layer 14 can be different. Examples of suitable density values include those in a range of from about 0.001 g/cm³ to about 5 g/cm³, 0.01 g/cm³to about 0.05 g/cm³, or less than, equal to, or greater than about 0.001 g/cm³, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 g/cm³. In some examples, the density of the respective porous layers are substantially uniform. For example, the density of any portion of any random portion of the porous layer can have a value that is substantially equivalent to the density of a second random portion of the porous layer. This is shown in FIG. 3, which is a schematic sectional view of first porous layer 12′. First porous layer 12′ shows porous layer including a non-woven fibrous material any description relating to first porous layer 12′ is equally applicable to first porous layer 12 and vice versa as well as to second porous layer 14. As shown in FIG. 3, fibers 19, having different lengths and thicknesses, are randomly distributed throughout first porous layer 12′ with no portion having a larger density value than any other portion of first porous layer 12′.

In other examples, however, first porous layer 12′ as well as second porous layer 14 can include a variable density in which at least two discrete portions of the same layer have different density values. An example of this is shown in FIG. 4, which is a sectional schematic view of first porous layer 12′ having a variable density. Throughout this disclosure, the features described with respect to first porous layer 12′ are equally applicable to second porous layer 14 or any additional porous layer.

As shown in FIG. 4, first porous layer 12′ includes adjacent protrusions 20, with cavities 22 dispersed therebetween. Portions 24 are located proximate to cavities 22. By virtue of the non-woven fibers being compressed adjacent to the cavities 22, the portions 24 have a density that is greater than a density of the balance of first porous layer 12′ comprised by portion 26.

Portions 24 are arranged in a predetermined pattern across first porous layer 12′. As shown in FIG. 4, portions 24 are spaced transversely with respect to each other at locations adjacent to cavities 22. The transverse spacing between portions 24 can be constant across first porous layer 12′ or variable. As shown, the thickness of each portion 24 is substantially the same, however, in other examples, the thickness of each portion 24 can be different. Relative to each other, the density of first porous layer 12′ at portion 24 can be in a range of from about 0.3 times to about 10.0 times greater than the density at portion 26, about 2.0 times to about 5.0 times greater, or less than, equal to, or greater than about 0.3 times, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or about 5.0 times greater than the density at portion 26.

The greater density value of portions 24 can be achieved, in part, by forming protrusions 24. As described further herein, protrusions 24 can be formed by providing or receiving porous layer 12′ or 14 having a uniform density (e.g., as shown with respect to FIG. 3) and selectively pressing regions of the porous layer. Regions that are free of pressing result in protrusions 20. A thickness of first porous layer 12′ at protrusions 24 is substantially commensurate with T₁ or T₂ as shown in FIGS. 1-3. However, a thickness of first porous layer 12′ at cavities 22, is reduced. For example, a thickness of first porous layer 12′ at protrusions 20 can be in a range of from about 3 times to about 10 times greater than a thickness of first porous layer 12′ at cavities 22, about 4 times to about 6 times greater, or less than, equal to, or greater than about 3 times, 3.5, 4, 4.5, 5, 5.5, 6, 6.5, 7, 7.5, 8, 8.5, 9, 9.5, or about 10 times greater than a thickness of first porous layer 12′ at cavities 22. In general, as the relative thickness of first porous layer 12′, between protrusions 20 and cavities 22 increases, the density of portions 24 relative to portions 26 increases accordingly.

Because portions 24 can be formed, at least in part, by forming protrusions 24 and cavities 22, the spacing between adjacent protrusions 20, forming cavities therebetween, can define the patterned arrangement of portions 24. For example, a distance between centers of adjacent protrusions can be in a range of from about 1 mm to about 50 mm, about 15 mm to about 25 mm, or less than, equal to, or greater than about 1 mm, 2, 3, 4, 5, 6, 7, 8, 9, 10, 11, 12, 13, 14, 15, 16, 17, 18, 19, 20, 21 ,22, 23, 24, 25, 26, 27, 28, 29, 30, 31, 32, 33, 34, 35, 36, 37, 38, 39, 40, 41, 42, 43, 44, 45, 46, 47, 48, 49, or about 50 mm. The space between the adjacent protrusions 20 can be where portions 24 are located. As shown in FIG. 4, protrusions 20 are arranged in a first row. In other examples, however, first porous layer 12′ can include any plural rows of protrusions 20 adjacent to each other. The arrangement of protrusions 20 and cavities 22 therebetween can function together to form the predetermined pattern of portions 24 in first porous layer 12′. The inventors have found that in some examples, forming first porous layer 12′ or second porous layer 14 to have a variable density can result in the porous layer having an increased flow resistance compared to a corresponding porous layer that is free of a plurality of protrusions and cavities.

Acoustic properties of first porous layer 12′ and second porous layer 14, such as flow resistance, vibration, or resonance frequency, can be further tuned by filing cavities 22 with a solid filler component. FIG. 5 is a schematic sectional view of first porous layer 12′ including solid filler component 28. Solid filler component 28 can be any suitable solid material. For example, solid filler component 28 can include a material chosen from a xenolith, a ceramic particle, and a mixture thereof. Any of these can be dispersed in a resin or a binder to form an agglomeration. Examples of binders include acrylate binders and polyurethane binders. Solid filler component 28 can at least partially fill cavity 22. In some examples, each cavity 22 includes solid filler component 28 and in other examples, less than all cavities can include solid filler component 28. As shown, in FIG. 5, solid filler component 28 is dimensioned as a rectangle to completely fill cavity 22. In other examples, however, solid filler component 28 can be dimensioned as a different shape that may only partially fill cavity 22. For example, solid filler component 28 can have any suitable generally circular, spherical, and polygonal shape. Including solid filler component 28, and the extent to which it fills cavity 22, can be useful in further tuning the acoustic properties of first porous layer 12′. For example, solid filler component 28 can add mass to acoustic composite 10, which can affect the resonance of composite 10 and improve low frequency acoustic absorption.

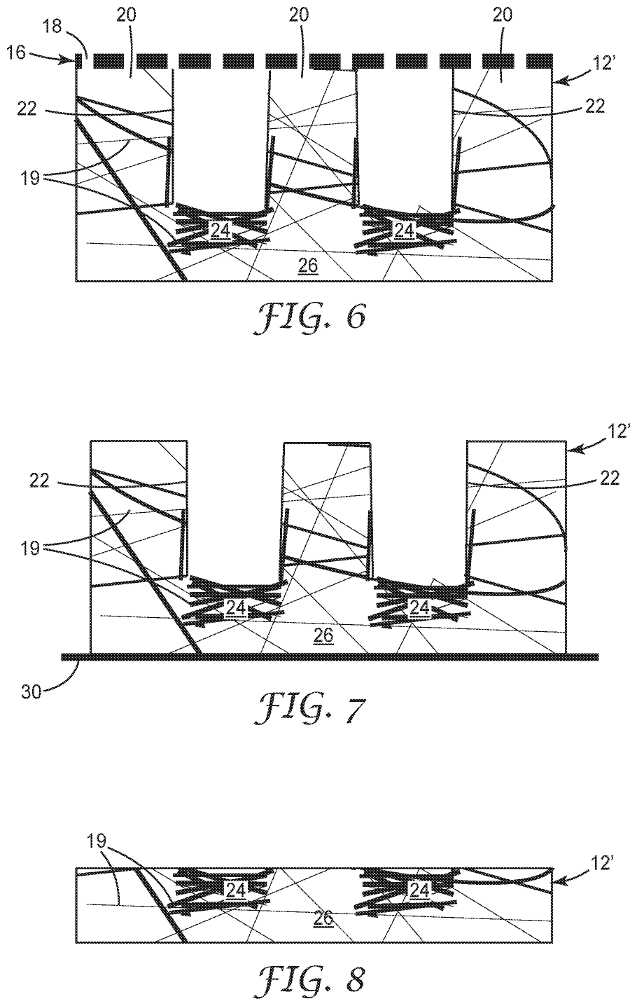

As described herein with respect to FIGS. 1 and 2, perforated membrane 16 is adjacent to at least one of first porous layer 12 and second porous layer 14. FIG. 6 is a schematic sectional view of first porous layer 12′ including perforated membrane 16. As described further herein, the inclusion and design of perforated membrane 16 can impact the acoustic properties of acoustic composite 10.

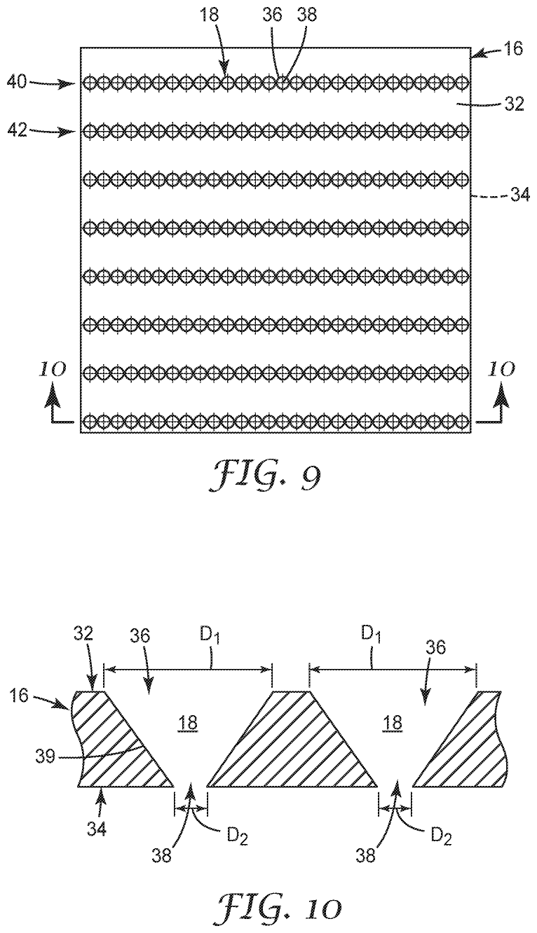

Another way to alter the acoustic properties of composite 10 is to include an elastomeric membrane that can be attached to first porous layer 12′, second porous layer 14, or perforated membrane 16. FIG. 7 is a schematic sectional view of first porous layer 12′ including elastomeric membrane 30 attached thereto. Elastomeric membrane 30 can be substantially free of porosity. Elastomeric membrane 30 can include any suitable material. Examples of suitable materials can include a fluoroelastomer, a rubber (e.g., neoprene), a silicone rubber, or a thermoplastic polyurethane.

In a further example of first porous layer 12′ or second porous layer 14, the respective layer can be free of protrusions 20 and cavities 22. An example is shown in FIG. 8, which is a sectional schematic view of first porous layer 12′ including a variable density but free of protrusions 20 and cavities 22. This can be formed by removing protrusions 20 or through direct densification of regions of first porous layer 12′ to form portions 24. Directly densifying first porous layer could include impregnating a section of the porous membrane with materials that could be hardened (e.g., through curing, cooling, or drying) to locally densify the porous layer or through surface treatment including coating the surface of the porous layer with a material that would add density. Additionally, specific regions of fibers could be coated with a material that hardens or cures thereon to locally increase density. In some examples, a thickness of first porous layer 12′ having a variable density, but that is free of protrusions 20, can be less thick than a corresponding first porous layer 12′ than includes protrusions 20. This can reduce the overall thickness of acoustic composite 10, which may desirable for various applications.

As shown in FIGS. 1, 2, and 6, acoustic composite 10 includes perforated membrane 16 adjacent to at least one of the first porous layer and the second porous layer. FIG. 9 is a top plan view of perforated membrane 16. As shown, perforated membrane 16 includes first surface 32 and second surface 34, which is opposed to first surface 32. Perforated membrane 16 further includes a patterned arrangement of a plurality of through-holes 18. Each of holes 18 extends between first open end 36 and second open end 38, defined by first surface 32 and second surface 34, respectively.

Perforated membrane 16 can include a material chosen from an acetate, an acrylate, a polyolefin, a polypropylene, a fluoropolymer, a polyamide, a polyimide, a polyether imide, a polyphenylene sulfide, a polycarbonate, a copolymer thereof, and a mixture thereof. Examples of suitable fluoropolymers include a fluoropolymer is chosen from a polytetrafluoroethylene, a tetrafluoroethylene-hexafluoropropylene-vinylidene fluoride polymer, polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluoropolyether, a copolymer thereof, and a mixture thereof.

Perforated membrane 16, or porous layers 12 and 14 in some examples, can be independently flame resistance by virtue of the materials forming perforated membrane 16 or porous layers 12 and 14. The materials can also be modified to increase flame resistance. However, in some examples any layer can include additional materials and components such as flame retardant additives. Some examples of flame retardants include, for example, polyamides, maleimides, or organophosphorous compounds such as organic phosphates (including trialkyl phosphates such as triethyl phosphate, tris(2-chloropropyl)phosphate, and triaryl phosphates such as triphenyl phosphate and diphenyl cresyl phosphate, resorcinol bis-diphenylphosphate, resorcinol diphosphate, and aryl phosphate), phosphites (including trialkyl phosphites, triaryl phosphites, and mixed alkyl-aryl phosphites), phosphonates (including diethyl ethyl phosphonate, dimethyl methyl phosphonate), polyphosphates (including melamine polyphosphate, ammonium polyphosphates), polyphosphites, polyphosphonates, phosphinates (including aluminum tris(diethyl phosphinate); halogenated fire retardants such as chlorendic acid derivatives and chlorinated paraffins; organobromines, such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anhydride, tetrabromobisphenol A (TBBPA) and hexabromocyclododecane (HBCD); metal hydroxides such as magnesium hydroxide, aluminum hydroxide, cobalt hydroxide, and hydrates of the foregoing metal hydroxide; and combinations thereof. The flame retardant can be a reactive type flame-retardant (including polyols which contain phosphorus groups, 10-(2,5-dihydroxyphenyl) -10H-9-oxa-10-phospha-phenanthrene-10-oxide, phosphorus-containing lactone-modified polyesters, ethylene glycol bis(diphenyl phosphate), neopentylglycol bis(diphenyl phosphate), amine- and hydroxyl-functionalized siloxane oligomers). These flame retardants can be used alone or in conjunction with other flame retardants. The flame retardants can be solid or liquid. The flame retardants can be added to perforated membrane 16, or porous layers 12 and 14, in any suitable way. For example, the flame retardants can be at least partially melted into a solution including molten materials forming perforated membrane 16 or porous layers 12 and 14. Alternatively, the flame retardants can be coated to the surface perforated membrane 16 or porous layers 12 and 14. Alternatively, the materials of perforate membrane 16 or porous membranes 12 and 14 can be modified.

The physical properties of perforated membrane 16, can be tuned to affect the acoustic properties of membrane 16. An example of a tunable physical property of perforated membrane includes a flexural modulus of perforated membrane 16. The flexible modulus can be at least about 500 MPa, at least about 600 MPa, at least about 700 MPa, at least about 800 MPa, at least about 900 MPa, at least about 1000 MPa, at least about 1100 MPa, at least about 1200 MPa, at least about 1300 MPa, at least about 1400 MPa, at least about 1500 MPa, at least about 1600 MPa, at least about 1700 MPa, at least about 1800 MPa, at least about 1900 MPa, or at least about 2000 MPa. Increasing the flexural modulus can increase the stiffness of perforated membrane 16, which can increase the flow resistance of perforated membrane 16 and acoustic composite 10. The flexural modulus can be a function of the thickness of perforated membrane 16. The thickness of (T₃) of perforated membrane 16 can be in a range of from about 0.1 mm to about 1 mm, about 0.2 mm to about 1 mm, or less than, equal to, or greater than, about 0.1 mm, 0.15, 0.2, 0.25, 0.3, 0.35, 0.4, 0.45, 0.5, 0.55, 0.6, 0.65, 0.7, 0.75, 0.8, 0.85, 0.9, 0.95, or about 1 mm.

In some examples of perforated membrane 16, each of through-holes 18 can be tapered. The tapered holes can be similar to those described in U.S. Pat. No. 6,598,701 (Wood), the contents of which are hereby incorporated by reference. This is shown in FIG. 10, which is a partial sectional view of perforated membrane 16 taken along line 10-10 of FIG. 9. As shown in FIG. 10, through-holes 18 are tapered such that an angle of side wall 39, extending between first open end 36 and second open end 38 is in a range of from about 5 degrees to about 35 degrees, about 7 degrees to about 15 degrees, or less than, equal to, or greater than about 5 degrees, 6, 7, 8, 9, 10, 11, 12, 13, 14, 15, 16, 17, 18, 19, 20, 21, 22, 23, 24, 25, 26, 27, 28, 29, 30, 31, 32, 33, 34, or about 35 degrees. The tapered shape can give through-holes 18 a substantially conical or frustoconical shape. In some examples, second open end 38 includes a lip at least partially circumscribing second open end 38 along second surface 34.

As a result of the tapering, a diameter (D₁) of first open end 36 can be larger than a diameter (D₂) of second open end 38. For example, a diameter of first open end 36 can be in a range of about 2 times to about 10 times greater than the diameter of the second open end 38, about 4 times to about 6 times greater, or less than, equal to, or greater than about 2 times, 2.5, 3, 3.5, 4, 4.5, 5, 5.5, 6, 6.5, 7, 7.5, 8, 8.5, 9, 9.5, or about 10 times greater than the diameter of the second open end 38. A diameter of first open end 36 and second open end 38 can be in a range of from about 10 μm to about 1000 μm, about 70 μm to about 80 μm, or less than, equal to, or greater than about 50 μm, 100, 150, 200, 250, 300, 350, 400, 450, 500, 550, 600, 650 ,700, 750, 800, 850, 900, 950, or about 1000 μm.

A profile of any one of first open end 36 and second open end 38 can be a generally circular profile. The generally circular profile can correspond to a perfect circle, and ellipse, or an oval. The profile can also be a polygonal profile. The polygonal profile can correspond a triangle, a square, a rectangle, a pentagon, a hexagon, a heptagon, and an octagon. In examples of first open end 36 and second open end 38, in which the profile does not correspond to a perfect circle, the diameter can correspond to a major width of the respective opening.

The presence of through-holes 18 allow for the tuning of the open area of perforated membrane 16. The open area represents the portion of the total volume of perforated membrane 16 that is defined by through-holes 18. The open area can be in a range of from about 0.1% to about 10% of the total volume of perforated membrane 16, about 1% to about 5%, or less than, equal to, or greater than about 0.1%, 0.5, 1, 1.5, 2, 2.5, 3, 3.5, 4, 4.5, 5, 5.5, 6, 6.5, 7, 7.5, 8, 8.5, 9, 9.5, or about 10% of the total volume of perforated membrane 16.

As shown in FIGS. 9 and 10, through-holes 18 are arranged in a pattern that is non-random. Through-holes 18 are shown as arranged in first row 40 with a space between adjacent through-holes 18 in the row being in a range of from about 0.05 mm to about 5 mm, about 0.05 mm to about 1 mm, or less than, equal to, or greater than about 0.05 mm, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or about 1 mm. FIG. 9 is not necessarily drawn to scale A distance between centers of adjacent through-holes 18 of first row 40 and second row 42, can be in a range of from about 1 mm to about 10 mm, about 3 mm to about 5 mm, or less than, equal to, or greater than about 1 mm, 1.5, 2, 2.5, 3, 3.5, 4, 4.5, 5, 5.5, 6, 6.5, 7, 7.5, 8, 8.5, 9, 9.5 or about 10 mm. As shown in FIG. 9, adjacent through-holes 18 of first row 40 are shown as directly aligned with those of second row 42. In other examples, adjacent through-holes 18 can be staggered with respect to each other. As shown further in FIGS. 9 and 10, the major diameter of each through-hole 18 are defined by first surface 32. In other examples, however, perforated membrane 16 can be designed such that the major diameter of at least some of through-holes 18 is defined by second surface.

By controlling, at least in part the parameters of perforated membrane 16 described herein, the flow resistance of perforated membrane 16 can be tuned to be any suitable value. For example, the flow resistance of perforated membrane can be in a range of from about 100 Rayl to about 150,000 Rayl, about 100 Rayl to about 10,000 Rayl, or less than, equal to, or greater than about 100 Rayl, 500 1,000, 5,000, 10,000, 20,000, 30,000, 40,000, 50,000, 60,000, 70,000, 80,000, 90,000, 100,000, 100,000, 120,000, 130,000, 140,000, or about 150,000 Rayl.

Perforated membrane 16 can be positioned relative to first porous layer 12 and second porous layer 14 in any suitable way. For example, as shown in FIG. 1, perforated membrane 16 can be positioned between first porous layer 12 and second porous layer 14. Alternatively, perforated membrane 16 can be positioned adjacent to only one of first porous layer 12 and second porous layer 14 such that membrane 16 is on the outside of acoustic composite 10. Perforated membrane 16 can be directly coupled to first porous layer 12 or second porous layer 14. Alternatively, perforated membrane 16 can be positioned adjacent to first porous layer 12 or second porous layer 14, but be free of direct coupling such that an air gap is defined therebetween. Acoustic composite 10 can include additional components coupled to first porous layer 12, second porous layer 14, or perforated membrane 16. Examples, of suitable additional components include a non-woven scrim, a hot melt layer, a fibrous web, and an adhesive layer.

While any component of acoustic composite 10 can include many suitable materials, in some examples, those materials are chosen from materials that allow the composite to be flame resistant as determined by a FAR25 856a flame test. In some examples, where perforated membrane 16 is located between first porous layer 12 and second porous layer 14, membrane 16 does not need to be independently flame resistant as it can be shielded by porous layers 12 and that have high flame resistance, such as fiberglass layers. This can expand the possibility of materials that membrane 16 can include, which can allow for selection of materials that offer desirable acoustic properties that may not be flame resistant as determined by a FAR25 856a flame test.

Acoustic composite 10 can be incorporated in many different applications for controlling sound transmission. For example, acoustic composite can be incorporated in a stationary structure, a land vehicle, an aquatic vehicle, or an aerospace vehicle. Examples of a stationary structure can include a building. Examples, of a land vehicle can include an automobile or a train. Examples of an aerospace vehicle can include an airplane, helicopter, or spacecraft.

When acoustic composite 10 is disposed in a structure or vehicle composite 10 can be positioned between two panels. In the case of an automobile or aircraft, a first panel can be an interior trim material and the second panel can be an exterior surface such as an automobile body or aircraft fuselage that can include a material such as steel or aluminum. In some additional examples, acoustic composite 10 can be disposed with a shell or bag that at least partially surrounds acoustic composite 10. The first and second panels are then attached to the shell. The shell can include any suitable material such as a polyvinyl fluoride, polyether ketone, polyether ether ketone, polyimide, a polyethylene, a polyvinylidene fluoride, an epoxy, or a mixture thereof. The shell can further include a reinforcing material chosen from a polyamide, a non-woven scrim, a mineral fiber, or a mixture thereof

In operation, acoustic composite 10, can be arranged such that first open ends 36 are substantially aligned with a noise source. An example of a noise source can include an engine such as a gas turbine engine or an automobile engine. To improve the acoustic performance of acoustic composite 10, first open end 36 and second open end 38 can be sized such that the respective diameters are smaller than sound of a predetermined wavelength. The predetermined wavelength can by based on a particular noise that a user may want to block or diminish.

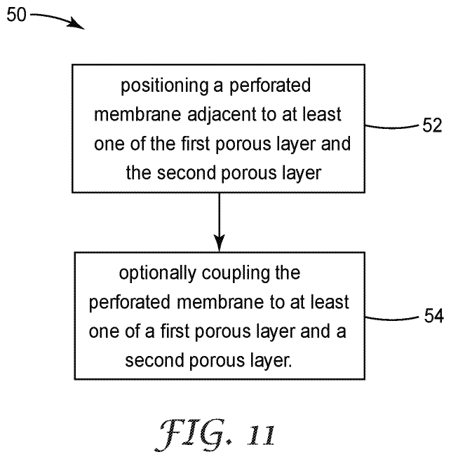

Acoustic composite 10 can be made through any suitable process. An example of a suitable process is shown in FIG. 11, which is a flow chart showing method 50 of forming acoustic composite 10. As shown in FIG. 11, operation 52 includes positioning perforated membrane 16 adjacent to at least one of first porous layer 12 and second porous layer 14. In operation 54 perforated membrane 16 is coupled to at least one of first porous layer 12 and second porous layer 14.

As described herein, in some examples, it may be desirable to form porous layers 12 and 14 to include a variable density. To accomplish this, a sheet of the materials described herein can be provided and protrusions 20 can be formed on a major surface of the sheet. To form protrusions 20, as well as cavities 22, discrete portions of the sheet that are transverse with respect to each other can be locally heated. This can decrease the thickness of those regions (forming cavities 22) and increase the density of the regions (forming portion 24). Alternatively, to form protrusions 20, as well as cavities 22, discrete portions of the sheet that are transverse with respect to each other can be locally exposed to above ambient air pressure. This can decrease the thickness of those regions (forming cavities 22) and increase the density of the regions (forming portion 24). Alternatively, to form protrusions 20 as well as cavities 22, the material can be globally heated and then pressure can be locally applied to select regions (forming cavities 22) which can increase the density of the regions (forming portion 24). Alternatively, to form protrusions, as well as cavities 22, the sheet can be feed through an assembly of rollers. One roller, that can be referred to as a forming roller, can include a plurality of posts that locally compress the sheet. Impacting the sheet with the posts can decrease the thickness of those regions (forming cavities 22) and increase the density of the regions (forming portion 24). The posts need not be located on a roller. Posts can also be located on an embossing plate that is selectively engaged with the sheet. Alternatively, additive manufacturing techniques can be employed to augment any production steps or to assemble first porous layer in its entirety. Any of protrusions 20, can be removed to provide a substantially flat major surface.

To provide first porous layer 12′ as shown in FIG. 5, at least one solid filler component 28 can be disposed in at least one cavity 22 between adjacent protrusions 20. Solid filler component 28 can be directly deposited therein or a mixture comprising at least one of a xenolith, a ceramic particle, or a mixture thereof dispersed within a resin or binder into cavity 22. The mixture can then be hardened. If the resins are curable resins, hardening can include crosslinking the curable resin. Hardening can also include cooling the mixture from a molten state. Hardening can further include drying mixture.

Perforated membrane 16 can be formed according to many suitable methods. For example, perforated membrane 16 can be formed by providing or receiving a sheet of a material chosen from an acetate, an acrylate, a polyolefin, a polypropylene, a copolymer thereof, and a mixture thereof. The plurality through-holes 18 are formed therein. Through-holes 18 can be formed by laser drilling or mechanical drilling. The drilling can be executed to tapper through-holes 18. Alternatively, through-holes 18 can be formed by feeding the sheet through an assembly of rollers. An example of such a process is found in U.S. Pat. No. 7,731,878 (Wood), to contents of which are hereby incorporated by reference. As described with respect to forming the first porous layer 12 and second porous layer 14, one roller, that can be referred to as a forming roller, can include a plurality of posts. The posts can be tapered. The posts locally impact the sheet. Impacting the sheet with the posts can decrease the thickness of those regions. In some cases, the posts can puncture the sheet to directly form through-hole 18. In other examples, through-hole 18 is only partially formed by posts. To fully open through-hole 18, the thin membrane that is left from post is exposed to heat such as by a flame to open second open end 38 and thus form through-hole 18. The posts need not be located on a roller. Posts can also be located on an embossing plate that is selectively engaged with the sheet. Alternatively, additive manufacturing techniques can be employed to augment any production steps or to assemble first porous layer in its entirety.

To ensure that through-holes 18 are disposed according to a predetermined pattern, posts on a forming roller or embossing plate can be purposefully arranged to produce a pattern of through-holes 18. Alternatively, if perforated membrane 16 is formed using drilling or through additive manufacturing the machine responsible for forming through-holes 18 can be controlled by a controller performing a series of steps issued by a computer readable medium such as a computer-aided design program.

### EXAMPLES

Various embodiments of the present invention can be better understood by reference to the following Examples which are offered by way of illustration. The present invention is not limited to the Examples given herein.

### EXAMPLES

TABLE 1
Materials

| Designation | Description | Source |
|---|---|---|
| FG-A | Fiberglass layer, 1 inch | John Mansville, |
| | (2.5 cm) thick, 0.5 pcf | Denver, CO |
| | (8 kg/m³), available under | |
| | the trade designation | |
| | “MICROLITE AA” | |
| FG-B | Fiberglass layer, 1 inch | John Mansville, |
| | (2.5 cm) thick, 1 pcf | Denver, CO |
| | (16 kg/m³), available under | |
| | the trade designation | |
| | “MICROLITE AA” | |
| LAMAGUARD | Bagging material made from | Lamart Corp., |
| 12 | aliphatic polyketone (APK) | Clifton, NJ |
| | reinforced by nylon and | |
| | adhesive, available under | |
| | the trade designation | |
| | “LAMAGUARD 12” | |

Preparation of a perforated membrane (“PM-1”)

A perforated membrane was made through an extrusion replication and then flame opening process, as described in U.S. Pat. No. 6,598,701. The perforated membrane was made from the polypropylene (Dow C700 grade). The geometry of the perforations was as generally illustrated in FIG. 6 of U.S. Pat, No. 6,598,701 (the description of which is incorporated herein by reference), with the following details: the through-holes in the perforated membrane had a tapered shape, having a widest diameter (see “604” in FIG. 6 of U.S. Pat, No. 6,598,701) of about 0.268 mm and a narrowest diameter (see “602” in FIG. 6 of U.S. Pat, No. 6,598,701) of about 0.1mm. The total wall-included angle was 25 degrees (full angle; half angle was 12.5 degrees). The perforated membranes tested had thickness of 0.43 mm. The through-holes were spaced about 1 mm apart. The total opening area of the perforated membrane was around 0.785%.

### Comparative Example 1 (CE-1)

A three-layer fiberglass construct was prepared by stacking an FG-A layer on the outboard side, followed by two layers of FG-B. The three-layer fiber glass structure was enclosed in a bag of LAMAGUARD 12, which was heat sealed around the periphery. Thus, there were three 1 inch (2.5 cm) layers of fiberglass, and there was no adhesive layer. In the constructs for CE-1, EX-1, and EX-2, “outboard” side referred to the outermost major surface of the FG-A layer, while “inboard” side referred to the outermost major surface of the FG-B layers. The outboard side was generally facing towards to a noise source during acoustic performance testing.

### Example 1 (EX-1)

A four-layer construct was prepared by inserting a layer of perforated membrane PM-1 between the two FG-B layers of CE-1, to obtain the following stack of layers in the following order from the outboard side to the inboard side: FG-A, FG-B, PM-1, FG-B. The orientation of the perforated membrane layer PM-1 was such that the larger openings of the tapered through-holes faced towards the FG-A layer. The four-layer construct was enclosed in a bag of LAMAGUARD 12, which was then heat sealed around the periphery.

### Example 2 (EX-2)

Starting with the three-layer fiberglass construct of CE-1, enclosed in the bag of LAMAGUARD 12, a layer of perforated membrane PM-1 was placed inboard of CE-1. Thus, the layer of PM-1 was disposed outside of the bag of LAMAGUARD 12. The orientation of the perforated membrane layer PM-1 was such that the larger diameter face of the tapered through-holes faced towards the three-layer fiberglass construct (and against the bag). There was no adhesive layer.

Acoustic performance testing—Transmission Loss

Following, the ASTM E90 09(2016) test for sound transmission loss, 0.9 m by 0.9 m samples were prepared, and tested in single wall set up with 0.04 inch (1.02 mm) thick aluminum skin layer (“A1 skin”) at the outboard (towards noise source) of tested samples. For CE-1, EX-1 and EX-2, the fiberglass layer FG-1 was facing the aluminum skin layer.

Transmission loss measurements for the aluminum skin layer alone (“bare A1 skin”), CE-1, EX-1 and EX-2 were as summarized in Table 2.

TABLE 2

Transmission loss (dB)

| Frequency, | Bare Al | Al skin + | Al skin + | Al skin + |
|---|---|---|---|---|
| Hz | skin | CE-1 | EX-1 | EX-2 |
| 100 | 4.7 | 6.1 | 6.4 | 6.2 |
| 125 | 7.2 | 7.9 | 7.3 | 7.4 |
| 160 | 8.6 | 7.9 | 7.4 | 7.5 |
| 200 | 7.3 | 7.6 | 7.2 | 7.3 |
| 250 | 10.7 | 10.5 | 9.8 | 9.8 |
| 315 | 12.6 | 12.4 | 13.9 | 13.3 |
| 400 | 15.3 | 16.5 | 19.2 | 18.8 |
| 500 | 16.0 | 21.3 | 23.9 | 23.7 |
| 630 | 18.1 | 25.4 | 27.9 | 27.7 |
| 800 | 20.4 | 30.3 | 33.2 | 32.6 |
| 1000 | 24.4 | 37.6 | 41.4 | 39.8 |
| 1250 | 27.1 | 43.3 | 47.2 | 45.7 |
| 1600 | 26.4 | 49.8 | 53.6 | 52.4 |
| 2000 | 26.8 | 56.8 | 60.8 | 59.4 |
| 2500 | 29.5 | 62.8 | 66.0 | 65.1 |
| 3150 | 31.9 | 67.0 | 68.5 | 68.6 |
| 4000 | 33.6 | 68.6 | 69.4 | 69.9 |
| 5000 | 36.1 | 68.7 | 69.7 | 69.4 |

Flame test data

A sample of EX-1 article passed a Federal Aviation Regulations FAR-25 856a (“856a”) flame propagation test. The EX-1 sample was asymmetrical, and thus was tested on both sides (3 specimens with outboard side up and 3 specimens with inboard side up). There was no afterflame (3 seconds allowed) and flame propagation was between 0.9-1.1 inch (2 inches (5.1 cm) allowed).

A sample of EX-2 article failed the 856a flame test, when tested with inboard side up (flame applied directly on the perforated membrane). Flame propagation and after-flame exceeded the acceptable test requirements.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments.

The following exemplary embodiments are provided, the numbering of which is not to be construed as designating levels of importance.

Embodiment 1 provides an acoustic composite comprising:

a first porous layer having a flow resistance in a range of from about 100 Rayl to about 150,000 Rayl;

a second porous layer having a flow resistance in a range of from about 100 Rayl to about 150,000 Rayl; and

a perforated membrane adjacent to at least one of the first porous layer and the second porous layer, the perforated membrane comprising:
a first surface,
a second surface opposed to the first surface, and
a patterned arrangement of a plurality of through-holes each independently extending from a first open end, the first surface comprising the first open end, to a second open end, the second surface comprising the second open end.

Embodiment 2 provides the acoustic composite of Embodiment 1, wherein at least one of the first porous layer and the second porous layer have a thickness independently in a range of from about 3 mm to about 75 mm.

Embodiment 3 provides the acoustic composite of any one of Embodiments 1 or 2, wherein at least one of the first porous layer and the second porous layer have a thickness independently in a range of from about 12.5 mm to about 30 mm.

Embodiment 4 provides the acoustic composite of any one of Embodiments 1-3, wherein the flow resistance of at least one of the first porous layer and the second porous layer is independently in a range of from about 300 Rayl to about 150,000 Rayl.

Embodiment 5 provides the acoustic composite of any one of Embodiments 1-4, wherein the perforated membrane has a flexural modulus of at least 500 MPa.

Embodiment 6 provides the acoustic composite of any one of Embodiments 1-5, wherein the perforated membrane has a flexural modulus of at least 1000 MPa.

Embodiment 7 provides the acoustic composite of any one of Embodiments 1-6, wherein a density of the first porous layer is different from a density of the second porous layer.

Embodiment 8 provides the acoustic composite of any one of Embodiments 1-6, wherein a density of the first porous layer is the same as a density of the second porous layer.

Embodiment 9 provides the acoustic composite of any one of Embodiments 7 or 8, wherein the density of the first porous layer and the density of the second porous layer are independently in a range of from about 0.001 g/cm³ to about 0.5 g/cm³.

Embodiment 10 provides the acoustic composite of any one of Embodiments 7-9, wherein the density of the first porous layer and the density of the second porous layer are independently in a range of from about 0.01 g/cm³to about 0.05 g/cm³.

Embodiment 11 provides the acoustic composite of any one of Embodiments 1-10, wherein a thickness of the first porous layer is in a range of from about 0.2 times to about 5 times as thick as the second porous layer.

Embodiment 12 provides the acoustic composite of any one of Embodiments 1-11, wherein a thickness of the first porous layer is in a range of from about 1 time to about 3 times as thick as the second porous layer.

Embodiment 13 provides the acoustic composite of any one of Embodiments 1-12, wherein a thickness of the second porous layer is in a range of from about 0.2 times to about 5 times as thick as the first porous layer.

Embodiment 14 provides the acoustic composite of any one of Embodiments 1-13, wherein a thickness of the second porous layer is in a range of from about 1 time to about 3 times as thick as the first porous layer.

Embodiment 15 provides the acoustic composite of any one of Embodiments 1-14, wherein a thickness of at least one of the first porous layer and the second porous layer is independently in a range of from about 5 mm to about 90 mm.

Embodiment 16 provides the acoustic composite of any one of Embodiments 1-15, wherein a thickness of at least one of the first porous layer and the second porous layer is independently in a range of from about 10 mm to about 50 mm.

Embodiment 17 provides the acoustic composite of any one of Embodiments 1-16, wherein a thickness of at least one of the first porous layer and the second porous layer is constant.

Embodiment 18 provides the acoustic composite of any one of Embodiments 1-16, wherein a thickness of at least one of the first porous layer and the second porous layer is variable.

Embodiment 19 provides the acoustic composite of any one of Embodiments 1-18, wherein at least one of the first and second porous layers independently comprises a material chosen from a foam, a semi-crystalline fiber, a melt-blown fiber, a fluoropolymer fiber, a glass fiber, and a mixture thereof.

Embodiment 20 provides the acoustic composite of Embodiment 19, wherein the foam comprises a polymer chosen from a polyethylene, a polyurethane, a polylactic acid, a polypropylene, an ethylene and methacrylate ester copolymer, a polyphenylene sulfide, a copolymer thereof, and a mixture thereof

Embodiment 21 provides the acoustic composite of Embodiment 19, wherein the fluoropolymer fiber is chosen from a polytetrafluoroethylene, a tetrafluoroethylene-hexafluoropropylene-vinylidene fluoride polymer, polyvinylfluoride, polyvinylidene fluoride, polytetrafluoroethylene, polychlorotrifluoroethylene, perfluoroalkoxy polymer, fluorinated ethylene-propylene, poly ethylenetetrafluoroethylene, poly ethylenechlorotrifluoroethylene, perfluoropolyether, a copolymer thereof, and a mixture thereof.

Embodiment 22 provides the acoustic composite of Embodiment 20, wherein the polymer is in a range of from about 80 wt % to about 100 wt % of the foam.

Embodiment 23 provides the acoustic composite of any one of Embodiments 21 or 22, wherein the polymer is in a range of from about 95 wt % to about 100 wt % of the foam.

Embodiment 24 provides the acoustic composite of any one of Embodiments 20-23, wherein the foam comprises different polymers.

Embodiment 25 provides the acoustic composite of Embodiment 19, wherein the semi-crystalline fiber is chosen from a polyolefin, a polypropylene, a polyethylene, a polyester, a polyethylene terephthalate, a polybutylene terephthalate, a polyamide, a polyurethane, a polybutene, a polylactic acid, a polyphenylene sulfide, a polysulfone, a liquid crystalline polymer, a polyethylene-co-vinylacetate, a polyacrylonitrile, a cyclic polyolefin, a polyamide, an acrylic, a rayon, a cellulose acetate, a polyvinyl chloride, a polyvinylidene chloride-vinyl chloride copolymer, a vinyl chloride-acrylonitrile copolymer, a copolymer thereof, a polyhydroxybutyrate, a polycaprolactone, a polyhydroxyalkanoate, a polyglycolide, a polybutylene succinate, a poly(3-hydroxybutyrate-co-3-hydroxyvalerate), a polyethylene adipate, a polyoxymethylene, a poly(vinylidine fluoride), a poly(ethylene-chlorotrifluoroethylene), a poly(vinyl fluoride), poly(ethylene oxide), a polycaprolactone, a semi-crystalline aliphatic polyamide, a thermotropic liquid crystal polymer, and a mixture thereof.

Embodiment 26 provides the acoustic composite of Embodiment 19, wherein the semi-crystalline fiber is a non-woven fiber.

Embodiment 27 provides the acoustic composite of Embodiment 19, wherein the semi-crystalline fiber has a median diameter of at least about 0.3 microns.

Embodiment 28 provides the acoustic composite of Embodiment 19, wherein the semi-crystalline fiber has a linear density in a range of from about 1 denier to about 15 denier.

Embodiment 29 provides the acoustic composite of any one of Embodiments 27 or 28, wherein the semi-crystalline fiber has a liner density in a range of from about 3 denier to about 8 denier.

Embodiment 30 provides the acoustic composite of Embodiment 19, wherein a Crimp Index Value of the semi-crystalline fiber is in a range of from about 15% to about 60%.

Embodiment 31 provides the acoustic composite of any one of Embodiments 1-30, wherein the first layer has a uniform density.

Embodiment 32 provides the acoustic composite of any one of Embodiments 1-31, wherein the first porous layer has a variable density defined by a first portion having a first density and a second portion spaced transversely with respect to the first portion, having a third density different than the first density.

Embodiment 33 provides the acoustic composite of Embodiment 32, wherein the first portion and second portion are arranged in a pattern.

Embodiment 34 provides the acoustic composite of any one of Embodiments 32 or 33, wherein the first density is in a range of from about 0.3 times to about 10 times greater than the third density.

Embodiment 35 provides the acoustic composite of any one of Embodiments 32-34, wherein the first density is in a range of from about 2 times to about 5 times greater than the third density.

Embodiment 36 provides the acoustic composite of any one of Embodiments 1-35, wherein the second porous layer has a variable density defined by a third portion having a second density and a fourth portion having a fourth density different than the second density.

Embodiment 37 provides the acoustic composite of Embodiment 36, wherein the second density is in a range of from about 0.3 times to about 10 times greater than the fourth density.

Embodiment 38 provides the acoustic composite of any one of Embodiments 36 or 37, wherein the second density is in a range of from about 2 times to about 5 times greater than the fourth density.

Embodiment 39 provides the acoustic composite of any one of Embodiments 1-38, wherein an external surface of at least one of the first porous layer and the second porous layer comprise a plurality of protrusions.

Embodiment 40 provides the acoustic composite of Embodiment 39, comprising a cavity between adjacent protrusions of at least one of the first porous layer and the second porous layer.

Embodiment 41 provides the acoustic composite of any one of Embodiments 39 or 40, wherein a thickness of each of the protrusions of at least one of the first porous layer and the second porous layer are independently in a range of from about 3 times to about 10 times greater than a thickness of the cavities the first porous layer and the second porous layer.

Embodiment 42 provides the acoustic composite of Embodiment 41, wherein a flow resistance of at least one of the first porous layer and the second porous layer is increased compared to a corresponding porous layer that is free of a plurality of protrusions and cavities.

Embodiment 43 provides the acoustic composite of any one of Embodiments 39-42, wherein a distance between adjacent protrusions is independently in a range of from about 1 mm to about 50 mm.

Embodiment 44 provides the acoustic composite of any one of Embodiments 39-43, wherein a distance between adjacent protrusions is independently in a range of from about 15 mm to about 25 mm.

Embodiment 45 provides the acoustic composite of any one of Embodiments 39-44, wherein the protrusions are arranged in a first row of protrusions.

Embodiment 46 provides the acoustic composite of any one of Embodiments 39-45, further comprising a second row of protrusions adjacent the first row of protrusions.

Embodiment 47 provides the acoustic composite of any one of Embodiments 40-46, further comprising a solid filler component at least partially filling the cavity.

Embodiment 48 provides the acoustic composite of Embodiment 47, wherein the solid filler component comprises an agglomeration of a material chosen from a xenolith, a resin, a binder a ceramic particle, and a mixture thereof.

Embodiment 49 provides the acoustic composite of any one of Embodiments 47 or 48, wherein the solid filler component is dimensioned to correspond to a negative impression of the cavity.

Embodiment 50 provides the acoustic composite of any one of Embodiments 47-49, wherein the solid filler component has at least one of a generally circular, spherical, and polygonal shape.

Embodiment 51 provides the acoustic composite of any one of Embodiments 1-50, further comprising an elastomeric membrane attached to at least one of the first porous layer, the second porous layer, and the perforated membrane.

Embodiment 52 provides the acoustic composite of Embodiment 51, wherein the elastomeric membrane comprises a material chosen from a fluoroelastomer, a rubber, a silicone rubber or a thermoplastic polyurethane.

Embodiment 53 provides the acoustic composite of any one of Embodiments 1-52, wherein the composite is flame resistant as determined by a FAR25 856a flame test.

Embodiment 54 provides the acoustic composite of any one of Embodiments 1-53, wherein a diameter of at least one of the first open end and the second open end is independently in a range of from about 10 μm to about 1000 μm.

Embodiment 55 provides the acoustic composite of any one of Embodiments 1-54, wherein a diameter of at least one of the first open end and the second open end is independently in a range of from about 50 μm to about 300 μm.

Embodiment 56 provides the acoustic composite of any one of Embodiments 1-55, wherein the perforated membrane has a thickness in a range of from about 0.1 mm to about 1 mm.

Embodiment 57 provides the acoustic composite of any one of Embodiments 1-56, wherein the perforated membrane has a thickness in a range of from about 0.2 mm to about 1 mm.

Embodiment 58 provides the acoustic composite of any one of Embodiments 1-57, wherein at least one through-hole is tapered and a diameter of the first open end is greater than a diameter of the second open end.

Embodiment 59 provides the acoustic composite of any one of Embodiments 1-58, wherein a side wall extending between the first opening and the second opening is angled at about 5 degrees to about 35 degrees.

Embodiment 60 provides the acoustic composite of any one of Embodiments 1-59, wherein a side wall extending between the first opening and the second opening is angled at about 7 degrees to about 15 degrees.

Embodiment 61 provides the acoustic composite of any one of Embodiments 1-60, wherein at least one of the first open end and the second open end of the through-holes each comprise a profile that comprises a generally circular perimeter or a polygonal perimeter.

Embodiment 62 provides the acoustic composite of Embodiment 61, wherein the polygonal perimeter is chosen from a triangle, a square, a rectangle, a pentagon, a hexagon, a heptagon, and an octagon.

Embodiment 63 provides the acoustic composite of Embodiment 62, wherein the generally circular perimeter is a circle, an ellipse, or an oval.

Embodiment 64 provides the acoustic composite of any one of Embodiments 58-63, wherein the individual through-holes have a substantially conical or frustoconical shape.

Embodiment 65 provides the acoustic composite of any one of Embodiments 58-64, wherein for at least one through-hole the first diameter of the first open end is in a range of about 2 times to about 10 times greater than the second diameter of the second open end.

Embodiment 66 provides the acoustic composite of any one of Embodiments 58-65, wherein for at least one through-hole the first diameter of the first open end is in a range of about 4 times to about 6 times greater than the second diameter of the second open end.

Embodiment 67 provides the acoustic composite of any one of Embodiments 1-66, wherein the second opening further comprises a lip at least partially circumscribing the second opening of the tapered through hole.

Embodiment 68 provides the acoustic composite of any one of Embodiments 1-67, wherein the plurality of through-holes define a void volume in a range of from about 0.1% to about 10% of the total volume of the perforated membrane.

Embodiment 69 provides the acoustic composite of any one of Embodiments 1-68, wherein the plurality of through-holes define a void volume in a range of from about 0.5% to about 5% of the total volume of the perforated membrane.

Embodiment 70 provides the acoustic composite of any one of Embodiments 1-69, wherein a distance between adjacent through-holes is independently in a range of from about 0.05 mm to about 5 mm.

Embodiment 71 provides the acoustic composite of any one of Embodiments 1-70, wherein a distance between adjacent through-holes is independently in a range of from about 0.5 mm to about 1.5 mm.

Embodiment 72 provides the acoustic composite of any one of Embodiments 1-71, wherein the perforated membrane comprises a material chosen from an acetate, an acrylate, a polyolefin, a polypropylene, a fluoropolymer, a polyamide, a polyimide, a polyether imide, a polyphenylene sulfide, a polycarbonate, a copolymer thereof, and a mixture thereof.

Embodiment 73 provides the acoustic composite of Embodiment 72, wherein the fluoropolymer is chosen from a polytetrafluoroethylene, a tetrafluoroethylene-hexafluoropropylene-vinylidene fluoride polymer, polyvinylfluoride, polyvinylidene fluoride, polytetrafluoroethylene, polychlorotrifluoroethylene, perfluoroalkoxy polymer, fluorinated ethylene-propylene, poly ethylenetetrafluoroethylene, poly ethylenechlorotrifluoroethylene, perfluoropolyether, a copolymer thereof, and a mixture thereof.

Embodiment 74 provides the acoustic composite of any one of Embodiments 1-73, wherein the perforated membrane is positioned between the first porous layer and the second porous layer.

Embodiment 75 provides the acoustic composite of any one of Embodiments 1-74, wherein the first porous layer and the second porous layer are attached to each other and the perforated membrane is adjacent to one of the porous layers.

Embodiment 76 provides the acoustic composite of Embodiment 75, wherein the perforated membrane is directly coupled to at least one of the first porous layer and the second porous layer.

Embodiment 77 provides the acoustic composite of any one of Embodiments 75 or 76, wherein the perforated membrane is spaced apart from at least one of the first porous layer and the second porous layer and an air gap is defined therebetween.

Embodiment 78 provides the acoustic composite of any one of Embodiments 1-77, wherein a flow resistance of the perforated membrane is in a range of from about 100 Rayl to about 150,000 Rayl.

Embodiment 79 provides the acoustic composite of any one of Embodiments 1-78, wherein a flow resistance of the perforated membrane is in a range of from about 100 Rayl to about 10,000 Rayl.

Embodiment 80 provides the acoustic composite of any one of Embodiments 1-79, further comprising at least one of a non-woven scrim, a hot melt layer, a web, and an adhesive layer adhered to at least one of the first porous layer or second porous layer.

Embodiment 81 provides an acoustic composite comprising:

a first porous layer and optionally a second porous layer independently comprising a material chosen from a foam, a semi-crystalline fiber, a melt-blown fiber, a glass fiber, a fluoropolymer fiber, and a mixture thereof, wherein at least one of the first porous layer and the second porous layer independently have a flow resistance in a range of from about 100 Rayl to about 150,000 Rayl and a variable density defined by a first portion having a first density and a second portion spaced transversely with respect to the first portion, having a second density different than the first density.

Embodiment 82 provides the acoustic composite of Embodiment 81, wherein at least one of the first porous layer and the second porous layer have a thickness independently in a range of from about 3 mm to about 75 mm.

Embodiment 83 provides the acoustic composite of any one of Embodiments 81 or 82, wherein at least one of the first porous layer and the second porous layer have a thickness independently in a range of from about 4 mm to about 50 mm.

Embodiment 84 provides the acoustic composite of any one of Embodiments 81-83, wherein the flow resistance of at least one of the first porous layer and the second porous layer is independently in a range of from about 100 Rayl to about 150,000 Rayl.

Embodiment 85 provides the acoustic composite of any one of Embodiments 81-84, wherein a thickness of the first porous layer is in a range of from about 0.2 times to about 5 times as thick as the second porous layer.

Embodiment 86 provides the acoustic composite of any one of Embodiments 81-85, wherein a thickness of the first porous layer is in a range of from about 1 time to about 3 times as thick as the second porous layer.

Embodiment 87 provides the acoustic composite of any one of Embodiments 81-86, wherein a thickness of the second porous layer is in a range of from about 0.2 times to about 5 times as thick as the first porous layer.

Embodiment 88 provides the acoustic composite of any one of Embodiments 81-87, wherein a thickness of the second porous layer is in a range of from about 1 time to about 3 times as thick as the first porous layer.

Embodiment 89 provides the acoustic composite of any one of Embodiments 81-88, wherein a thickness of at least one of the first porous layer and the second porous layer is independently in a range of from about 5 mm to about 90 mm.

Embodiment 90 provides the acoustic composite of any one of Embodiments 81-89, wherein a thickness of at least one of the first porous layer and the second porous layer is independently in a range of from about 10 mm to about 50 mm.

Embodiment 91 provides the acoustic composite of any one of Embodiments 81-90, wherein a thickness of at least one of the first porous layer and the second porous layer is constant.

Embodiment 92 provides the acoustic composite of any one of Embodiments 81-91, wherein a thickness of at least one of the first porous layer and the second porous layer is variable.

Embodiment 93 provides the acoustic composite of any one of Embodiments 81-92, wherein at least one of the first and second porous layers independently comprises a glass fiber.

Embodiment 94 provides the acoustic composite of any one of Embodiments 1-93, wherein the foam comprises a polymer chosen from a polyethylene, a polyurethane, a polylactic acid, a polypropylene, an ethylene and methacrylate ester copolymer, a polyphenylene sulfide, a copolymer thereof, and a mixture thereof.

Embodiment 95 provides the acoustic composite of Embodiment 81, wherein the fluoropolymer is chosen from a polytetrafluoroethylene, a tetrafluoroethylene-hexafluoropropylene-vinylidene fluoride polymer, polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluoropolyether, a copolymer thereof, and a mixture thereof.

Embodiment 96 provides the acoustic composite of any one of Embodiments 94 or 95, wherein the polymer is in a range of from about 80 wt % to about 100 wt % of the foam.

Embodiment 97 provides the acoustic composite of any one of Embodiments 94-96, wherein the polymer is in a range of from about 95 wt % to about 100 wt % of the foam.

Embodiment 98 provides the acoustic composite of any one of Embodiments 94-97, wherein the foam comprises different polymers.

Embodiment 99 provides the acoustic composite of any one of Embodiments 81-98, wherein the semi-crystalline fiber is chosen from a polyolefin, a polypropylene, a polyethylene, a polyester, a polyethylene terephthalate, a polybutylene terephthalate, a polyamide, a polyurethane, a polybutene, a polylactic acid, a polyphenylene sulfide, a polysulfone, a liquid crystalline polymer, a polyethylene-co-vinylacetate, a polyacrylonitrile, a cyclic polyolefin, a polyamide, an acrylic, a rayon, a cellulose acetate, a polyvinyl chloride, a polyvinylidene chloride-vinyl chloride copolymer, a vinyl chloride-acrylonitrile copolymer, a copolymer thereof, a polyhydroxybutyrate, a polycaprolactone, a polyhydroxyalkanoate, a polyglycolide, a polybutylene succinate, a poly(3-hydroxybutyrate-co-3-hydroxyvalerate), a polyethylene adipate, a polyoxymethylene, a poly(vinylidine fluoride), a poly(ethylene-chlorotrifluoroethylene), a poly(vinyl fluoride), poly(ethylene oxide), a polycaprolactone, a semi-crystalline aliphatic polyamide, a thermotropic liquid crystal polymer, .and a mixture thereof.

Embodiment 100 provides the acoustic composite of any one of Embodiments 81-99, wherein the semi-crystalline fiber is a non-woven fiber.

Embodiment 101 provides the acoustic composite of any one of Embodiments 81-100, wherein the semi-crystalline polymer has a median diameter of at least about 3 microns.

Embodiment 102 provides the acoustic composite of any one of Embodiments 81-101, wherein the semi-crystalline fiber has a linear density in a range of from about 1 denier to about 20 denier.

Embodiment 103 provides the acoustic composite of any one of Embodiments 81-102, wherein a Crimp Index Value of the semi-crystalline fiber is in a range of from about 15% to about 60%.

Embodiment 104 provides the acoustic composite of any one of Embodiment 81-103, wherein the first portion and second portion are arranged in a pattern.

Embodiment 105 provides the acoustic composite of Embodiment 104, wherein the first density is in a range of from about 0.3 times to about 10 times greater than the second density.

Embodiment 106 provides the acoustic composite of any one of Embodiments 104 or 105, wherein the first density is in a range of from about 2 times to about 5 times greater than the second density.

Embodiment 107 provides the acoustic composite of Embodiment 82, wherein the third density is in a range of from about 0.3 times to about 10 times greater than the fourth density.

Embodiment 108 provides the acoustic composite of Embodiment 107, wherein the third density is in a range of from about 2 times to about 5 times greater than the fourth density.

Embodiment 109 provides the acoustic composite of any one of Embodiments 82-108, wherein an external surface of at least one of the first porous layer and the second porous layer comprise a plurality of protrusions.

Embodiment 110 provides the acoustic composite of Embodiment 109, comprising a cavity between adjacent protrusions of at least one of the first porous layer and the second porous layer.

Embodiment 111 provides the acoustic composite of any one of Embodiments 109 or 110, wherein a thickness of each of the protrusions of at least one of the first porous layer and the second porous layer are independently in a range of from about 3 times to about 10 times greater than a thickness of the cavities the first porous layer and the second porous layer.

Embodiment 112 provides the acoustic composite of any one of Embodiments 109-111, wherein a flow resistance of at least one of the first porous layer and the second porous layer is increased compared to a corresponding porous layer that is free of a plurality of protrusions and cavities.

Embodiment 113 provides the acoustic composite of any one of Embodiments 109-112, wherein a distance between adjacent protrusions is independently in a range of from about 1 mm to about 50 mm.

Embodiment 114 provides the acoustic composite of any one of Embodiments 109-113, wherein a distance between adjacent protrusions is independently in a range of from about 15 mm to about 25 mm.

Embodiment 115 provides the acoustic composite of any one of Embodiments 109-114, wherein the protrusions are arranged in a first row of protrusions.

Embodiment 116 provides the acoustic composite of any one of Embodiments 109-115, further comprising a second row of protrusions adjacent the first row of protrusions.

Embodiment 117 provides the acoustic composite of any one of Embodiments 109-116, further comprising a solid filler component at least partially filling the cavity.

Embodiment 118 provides the acoustic composite of Embodiment 117, an agglomeration of a material chosen from a xenolith, a resin, a binder a ceramic particle, and a mixture thereof.

Embodiment 119 provides the acoustic composite of any one of Embodiments 117 or 118, wherein the solid filler component is dimensioned to correspond to a negative impression of the cavity.

Embodiment 120 provides the acoustic composite of any one of Embodiments 117-119, wherein the solid filler component has at least one of a generally circular, spherical, and polygonal shape.

Embodiment 121 provides the acoustic composite of any one of Embodiments 81-120, further comprising an elastomeric membrane attached to at least one of the first porous layer, the second porous layer, and the perforated membrane.

Embodiment 122 provides the acoustic composite of Embodiment 121, wherein the elastomeric membrane comprises a material chosen from a fluoroelastomer, a rubber, a silicone rubber or a thermoplastic polyurethane.

Embodiment 123 provides the acoustic composite of any one of Embodiments 81-122, further comprising:

a perforated membrane adjacent to at least one of the first porous layer and the second porous layer, the perforated membrane comprising:
a first surface,
a second surface opposed to the first surface, and
a patterned arrangement of a plurality of through-holes each independently extending from a first open end, the first surface comprising the first open end, to a second open end, the second surface comprising the second open end.

Embodiment 124 provides the acoustic composite of Embodiment 123, wherein a diameter of at least one of the first open end and the second open end is independently in a range of from about 10 μm to about 1000 μm.

Embodiment 125 provides the acoustic composite of any one of Embodiments 123 or 124, wherein a diameter of at least one of the first open end and the second open end is independently in a range of from about 50 μm to about 300 μm.

Embodiment 126 provides the acoustic composite of any one of Embodiments 123-125, wherein the perforated membrane has a thickness in a range of from about 0.1 mm to about 1 mm.

Embodiment 127 provides the acoustic composite of any one of Embodiments 123-126, wherein the perforated membrane has a thickness in a range of from about 0.2 mm to about 0.4 mm.

Embodiment 128 provides the acoustic composite of any one of Embodiments 123-127, wherein at least one through-hole is tapered and a diameter of the first open end is greater than a diameter of the second open end.

Embodiment 129 provides the acoustic composite of any one of Embodiments 123-128, wherein a side wall extending between the first opening and the second opening is angled at about 5 degrees to about 35 degrees.

Embodiment 130 provides the acoustic composite of any one of Embodiments 123-129, wherein a side wall extending between the first opening and the second opening is angled at about 7 degrees to about 15 degrees.

Embodiment 131 provides the acoustic composite of any one of Embodiments 123-130, wherein at least one of the first open end and the second open end of the through-holes each comprise a profile that comprises a generally circular perimeter or a polygonal perimeter.

Embodiment 132 provides the acoustic composite of Embodiment 131, wherein the polygonal perimeter is a triangle, a square, a rectangle, a pentagon, a hexagon, a heptagon, or an octagon.

Embodiment 133 provides the acoustic composite of Embodiment 131, wherein the generally circular perimeter is a circle, an ellipse, or an oval.

Embodiment 134 provides the acoustic composite of any one of Embodiments 128-133, wherein the individual through-holes have a substantially conical or frustoconical shape.

Embodiment 135 provides the acoustic composite of any one of Embodiments 128-134, wherein for at least one through-hole the first diameter of the first open end is in a range of about 2 times to about 10 times greater than the second diameter of the second open end.

Embodiment 136 provides the acoustic composite of any one of Embodiments 128-135, wherein at least one through-hole the first diameter of the first open end is in a range of about 4 times to about 6 times greater than the second diameter of the second open end.

Embodiment 137 provides the acoustic composite of any one of Embodiments 123-136, wherein a flexural modulus of the perforated membrane is in a range of from about 1000 MPa to about 2000 MPa.

Embodiment 138 provides the acoustic composite of any one of Embodiments 123-137, wherein a flexural modulus of the perforated membrane is in a range of from about 1300 MPa to about 1700 MPa.

Embodiment 139 provides the acoustic composite of any one of Embodiments 123-138, wherein the second opening further comprises a lip at least partially circumscribing the second opening of the tapered through hole.

Embodiment 140 provides the acoustic composite of any one of Embodiments 123-139, wherein the plurality of through-holes define a void volume in a range of from about 0.1% to about 10% of the total volume of the perforated membrane.

Embodiment 141 provides the acoustic composite of any one of Embodiments 123-140, wherein the plurality of through-holes define a void volume in a range of from about 1% to about 5% of the total volume of the perforated membrane.

Embodiment 142 provides the acoustic composite of any one of Embodiments 123-141, wherein a distance between adjacent through-holes is independently in a range of from about 0.05 mm to about 5 mm.

Embodiment 143 provides the acoustic composite of any one of Embodiments 123-142, wherein a distance between adjacent through-holes is independently in a range of from about 0.8 mm to about 1.5 mm.

Embodiment 144 provides the acoustic composite of any one of Embodiments 123-143, wherein the perforated membrane comprises a material chosen from an acetate, an acrylate, a polyolefin, a polypropylene, a fluoropolymer, a polyamide, a polyimide, a polyether imide, a polyphenylene sulfide, a polycarbonate, a copolymer thereof, and a mixture thereof.

Embodiment 145 provides the acoustic composite of Embodiment 144, wherein the fluoropolymer is chosen from a polytetrafluoroethylene, a tetrafluoroethylene-hexafluoropropylene-vinylidene fluoride polymer, polyvinylfluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluoropolyether, a copolymer thereof, and a mixture thereof.

Embodiment 146 provides the acoustic composite of any one of Embodiments 123-145, wherein the perforated membrane is positioned between the first porous layer and the second porous layer.

Embodiment 147 provides the acoustic composite of any one of Embodiments 123-146, wherein the first porous layer and the second porous layer are attached to each other and the perforated membrane is adjacent to one of the porous layers.

Embodiment 148 provides the acoustic composite of Embodiment 147, wherein the perforated membrane is directly coupled to at least one of the first porous layer and the second porous layer.

Embodiment 149 provides the acoustic composite of any one of Embodiments 147 or 148, wherein a flow resistance of the perforated membrane is in a range of from about 100 Rayl to about 150,000 Rayl.

Embodiment 150 provides the acoustic composite of any one of Embodiments 123-149, wherein a flow resistance of the perforated membrane is in a range of from about 100 Rayl to about 10,000 Rayl.

Embodiment 151 provides the acoustic composite of any one of Embodiments 123-150, wherein a flow resistance of the perforated membrane is in a range of from about 1,000 Rayl to about 5,000 Rayl.

Embodiment 152 provides the acoustic composite of any one of any one of Embodiments 123-151, further comprising at least one of a non-woven scrim, a hot melt layer, a web, and an adhesive layer adhered to at least one of the first porous layer or second porous layer.

Embodiment 153 provides an acoustic composite comprising:

a first porous layer having a first density and a flow resistance in a range of from about 100 Rayl to about 150,000 Rayl;

a second porous layer having a second density and a flow resistance in a range of from about 100 Rayl to about 150,000 Rayl,

wherein at least one of the first and second porous layers independently comprises a material chosen from a foam, a semi-crystalline fiber, or a mixture thereof, and have a variable density; and

a perforated membrane adjacent to at least one of the first porous layer and the second porous layer, the perforated membrane comprising:
a first surface,
an opposed second surface, and
a plurality of tapered through holes extending from a first open end, defined by the first surface, to a second open end defined by the second surface, a first diameter of the first open end being greater than a second diameter of the second end;

wherein the first open end and the second open end of the tapered through-holes each have a profile defined by a generally circular perimeter or a polygonal perimeter.

Embodiment 154 provides an assembly comprising:

the acoustic composite of any one of Embodiments 1-153;

a first panel and a second panel adjacent to the first porous layer and second porous layer respectively of the acoustic composite.

Embodiment 155 provides the assembly of Embodiment 154, further comprising a shell at least partially surrounding the acoustic composite.

Embodiment 156 provides the assembly of Embodiment 155, wherein the shell comprises a material chosen from a polyvinyl fluoride, polyether ketone, polyether ether ketone, polyimide, a polyethylene, a polyvinylidene fluoride, an epoxy, or a mixture thereof.

Embodiment 157 provides the assembly of Embodiment 156, wherein the shell further comprises a reinforcing material chosen from a polyamide, a glass fiber, a non-woven scrim, a mineral fiber, or a mixture thereof.

Embodiment 158 provides the assembly of any one of Embodiments 154-157, wherein the first panel is a vehicle body.

Embodiment 159 provides the assembly of any one of Embodiments 154-158, wherein the first panel comprises aluminum, steel, or a mixture thereof.

Embodiment 160 provides the assembly of any one of Embodiments 159-159, wherein the second panel is an interior trim.

Embodiment 161 provides the assembly of any one of Embodiments 159-160, wherein the second panel comprises wood, a composite, or a combination thereof.

Embodiment 162 provides the assembly of any one of Embodiments 159-161, wherein the vehicle body is an aircraft fuselage or a car body.

Embodiment 163 provides a method of using the acoustic composite of any one of Embodiments 1-158, the method comprising exposing the first open ends of the plurality of the through-holes to a noise source.

Embodiment 164 provides the method of Embodiment 163, wherein the noise source is an engine.

Embodiment 165 provides the method of Embodiment 164, wherein the engine is an automobile engine or an aircraft engine.

Embodiment 166 provides the method of any one of Embodiments 163-165, wherein at least one of the first diameter and the second diameter are sized to be smaller than an amplitude of a predetermined wavelength.

Embodiment 167 provides the method of any one of Embodiments 163-166, wherein the acoustic composite is free of a through-hole having a diameter of at least 100 μm.

Embodiment 168 provides a method of making the acoustic composite of any one of Embodiment 1-167, the method comprising:

positioning the perforated membrane adjacent to at least one of the first porous layer and the second porous layer; and

optionally coupling the perforated membrane to at least one of the first porous layer and the second porous layer.

Embodiment 169 provides the method of Embodiment 168, further comprising forming the at least one of the first porous layer and the second porous layer, comprising:

providing or receiving a sheet comprising a material chosen from a foam, a semi-crystalline fiber, a melt-blown fiber, and a mixture thereof; and

forming a plurality of protrusions on a first major surface of the sheet.

Embodiment 170 provides the method of Embodiment 169, wherein forming the plurality of protrusions comprises at least one of:

locally heating discrete portions transverse with respect to each other of the first major surface to decrease the thickness of the first porous layer and increase the local density of the material;

locally applying air pressure to discrete portions transverse with respect to each other of the first major surface to decrease the thickness of the first porous layer and increase the local density of the material;

engaging a pressing tool comprising a plurality of posts with the first major surface to decrease the thickness of the first porous layer and increase the local density of the material; and

globally heating the first major surface followed by at least one of:
locally applying air pressure to discrete portions transverse with respect to each other of the first major surface to decrease the thickness of the first porous layer and increase the local density of the material; and
engaging a pressing tool comprising a plurality of posts with the first major surface to decrease the thickness of the first porous layer and increase the local density of the material.

Embodiment 171 provides the method of any one of Embodiments 169 or 170, further comprising disposing at least one solid filler component in a cavity defined between adjacent protrusions.

Embodiment 172 provides the method of any one of Embodiments 168-171, wherein disposing the solid filler component comprises:

disposing a mixture comprising at least one of a carbon particle, an aerogel, a zeolite, a xenolith, a ceramic particle, or a mixture thereof dispersed within a resin into the cavity; and

hardening the mixture.

Embodiment 173 provides the method of any one of Embodiments 169-172, further comprising removing the plurality of protrusions such that the first major surface is substantially flat.

Embodiment 174 provides the method of any one of Embodiments 168-173, wherein forming the at least one of the first porous layer and the second porous layer comprises additive manufacturing.

Embodiment 175 provides the method of any one of Embodiments 168-174, further comprising forming the perforated membrane.

Embodiment 176 provides the method of Embodiment 175, wherein forming the perforated membrane comprises:

providing or receiving a sheet of a material chosen from an acetate, an acrylate, a polyolefin, a polypropylene, a copolymer thereof, and a mixture thereof; and

forming the plurality of through-holes therein.

Embodiment 177 provides the method of Embodiment 176, wherein forming the plurality of through-holes, comprises at least one of:

laser drilling;

mechanical drilling; and

pressing a tool comprising a plurality of posts against a first surface of the sheet to form a plurality of tapered cavities extending from the first major surface and exposing a second major surface to a flame to open the cavity and form the second end of the of the plurality of tapered through holes.

Embodiment 178 provides the method of Embodiment 177, wherein the perforated membrane is formed through an additive manufacturing process.

Embodiment 179 provides a method of forming a porous sheet, the method comprising:

providing or receiving a sheet comprising a material chosen from a foam, a semi-crystalline fiber, a melt-blown fiber, and a mixture thereof; and

forming a plurality of protrusions on a first major surface of the sheet.

Embodiment 180 provides the method of Embodiment 179, wherein forming the plurality of protrusions comprises at least one of:

locally heating discrete portions transverse with respect to each other of the first major surface to decrease the thickness of the first porous layer and increase the local density of the material;

locally applying air pressure to discrete portions transverse with respect to each other of the first major surface to decrease the thickness of the first porous layer and increase the local density of the material;

engaging a pressing tool comprising a plurality of posts with the first major surface to decrease the thickness of the first porous layer and increase the local density of the material; and

globally heating the first major surface followed by at least one of:
locally applying air pressure to discrete portions transverse with respect to each other of the first major surface to decrease the thickness of the first porous layer and increase the local density of the material; and
engaging a pressing tool comprising a plurality of posts with the first major surface to decrease the thickness of the first porous layer and increase the local density of the material.

Embodiment 181 provides the method of any one of Embodiments 179 or 180, further comprising disposing at least one solid filler component in a cavity defined between adjacent protrusions.

Embodiment 182 provides the method of any one of Embodiments 179-181, further comprising removing the plurality of protrusions such that the first major surface is substantially flat.

Embodiment 183 provides the method of any one of Embodiments 179-182, wherein forming the at least one of the first porous layer and the second porous layer comprises additive manufacturing.

1. An acoustic composite comprising:
a first porous layer having a flow resistance in a range of from about 100 Rayl to about 150,000 Rayl;
a second porous layer having a flow resistance in a range of from about 100 Rayl to about 150,000 Rayl; and
a perforated membrane adjacent to at least one of the first porous layer and the second porous layer, the perforated membrane comprising:
a first surface,
a second surface opposed to the first surface, and
a patterned arrangement of a plurality of through-holes each independently extending from a first open end, the first surface comprising the first open end, to a second open end, the second surface comprising the second open end.

2. The acoustic composite of claim 1, wherein at least one of the first porous layer and the second porous layer has a thickness independently in a range of from about 3 mm to about 75 mm.

3. The acoustic composite of claim 1, wherein the flow resistance of at least one of the first porous layer and the second porous layer is independently in a range of from about 300 Rayl to about 150,000 Rayl.

4. The acoustic composite of claim 1, wherein the perforated membrane has a flexural modulus of at least 500 MPa.

5. The acoustic composite of claim 1, wherein a density of the first porous layer and a density of the second porous layer are independently in a range of from about 0.001 g/cm³ to about 5 g/cm³.

6. The acoustic composite of claim 1, wherein the first porous layer has a variable density defined by a first portion having a first density and a second portion spaced transversely with respect to the first portion, having a third density different than the first density.

7. The acoustic composite of any one of claims 1-6, wherein at least one through-hole is tapered.

8. The acoustic composite of claim 7, wherein at least one through-hole the first diameter of the first open end is in a range of about 2 times to about 10 times greater than the second diameter of the second open end.

9. The acoustic composite of claim 1, wherein the plurality of through-holes define a void volume in a range of from about 0.1% to about 10% of the total volume of the perforated membrane.

10. The acoustic composite of claim 1, wherein a distance between centers of adjacent through-holes is independently in a range of from about 0.05 mm to about 5 mm.

11. The acoustic composite of claim 1, wherein the perforated membrane comprises a material chosen from an acetate, an acrylate, a polyolefin, a polypropylene, a fluoropolymer, a polyamide, a polyimide, a polyether imide, a polyphenylene sulfide, a polycarbonate, a copolymer thereof, and a mixture thereof.

12. The acoustic composite of claim 1, wherein the perforated membrane is directly coupled to at least one of the first porous layer and the second porous layer.

13. The acoustic composite of claim 1, wherein the perforated membrane is spaced apart from at least one of the first porous layer and the second porous layer and an air gap is defined therebetween.

14. An acoustic composite comprising:
a first porous layer having a first density and a flow resistance in a range of from about 100 Rayl to about 150,000 Rayl;
a second porous layer having a second density and a flow resistance in a range of from about 100 Rayl to about 150,000 Rayl,
wherein at least one of the first and second porous layers independently comprises a material chosen from a foam, a semi-crystalline fiber, or a mixture thereof, and have a variable density; and
a perforated membrane adjacent to at least one of the first porous layer and the second porous layer, the perforated membrane comprising:
a first surface,
an opposed second surface, and
a plurality of tapered through holes extending from a first open end, defined by the first surface, to a second open end defined by the second surface, a first diameter of the first open end being greater than a second diameter of the second end;
wherein the first open end and the second open end of the tapered through-holes each have a profile defined by a generally circular perimeter or a polygonal perimeter.

15. A method of making the acoustic composite of claim 1, the method comprising:
positioning the perforated membrane adjacent to at least one of the first porous layer and the second porous layer; and
optionally coupling the perforated membrane to at least one of the first porous layer and the second porous layer.

16. The method of claim 15, further comprising forming the at least one of the first porous layer and the second porous layer, comprising:
providing or receiving a sheet comprising a material chosen from a foam, a semi-crystalline fiber, a melt-blown fiber, and a mixture thereof; and
forming a plurality of protrusions on a first major surface of the sheet.

17. The method of claim 16, wherein forming the plurality of protrusions comprises at least one of:
locally heating discrete portions transverse with respect to each other of the first major surface to decrease the thickness of the first porous layer and increase the local density of the material;
locally applying air pressure to discrete portions transverse with respect to each other of the first major surface to decrease the thickness of the first porous layer and increase the local density of the material;
engaging a pressing tool comprising a plurality of posts with the first major surface to decrease the thickness of the first porous layer and increase the local density of the material; and
globally heating the first major surface followed by at least one of:
locally applying air pressure to discrete portions transverse with respect to each other of the first major surface to decrease the thickness of the first porous layer and increase the local density of the material; and
engaging a pressing tool comprising a plurality of posts with the first major surface to decrease the thickness of the first porous layer and increase the local density of the material.

18. The method of claim 14, wherein the variable density comprises a first portion having a first density and a second portion spaced transversely with respect to the first portion, having a third density different than the first density.

19. The method of claim 15, further comprising
forming the perforated membrane, wherein forming the perforated membrane comprises:
providing or receiving a sheet of a material chosen from an acetate, an acrylate, a polyolefin, a polypropylene, a copolymer thereof, and a mixture thereof; and
forming the plurality of through-holes therein.

20. The method of claim 19, wherein forming the plurality of through-holes, comprises at least one of:
laser drilling;
mechanical drilling; and
pressing a tool comprising a plurality of posts against a first surface of the sheet to form a plurality of tapered cavities extending from the first major surface and exposing a second major surface to a flame to open the cavity and form the second end of the of the plurality of tapered through holes.
